(19) United States
(12) Patent Application Publication
(10) Pub. No.: US 2026/0310665 A1
(43) Pub. Date: Oct. 8, 2026

(54) EARLY STOPPING SCHEME FOR BUDGET AWARE INDEX TUNING

(71) Applicant: Microsoft Technology Licensing, LLC, Redmond, WA (US)

(72) Inventors: Wentao WU, Kirkland, WA (US); Surajit CHAUDHURI, Kirkland, WA (US); Vivek Ravindranath NARASAYYA, Redmond, WA (US)

(73) Assignee: Microsoft Technology Licensing, LLC, Redmond, WA (US)

(21) Appl. No.: 19/095,924

(22) Filed: Mar. 31, 2025

(51) Int. Cl. G06F 16/2453; G06F 16/22

(52) U.S. Cl. CPC G06F 16/24542; G06F 16/2272

(57) ABSTRACT

An early stopping checking and verification process includes deriving a workload lower bound and a workload upper bound on what-if cost for an index tuning curve for a workload as what-if calls are being made. The index tuning curve represents a function that maps a number of what-if calls allocated to a percentage improvement of a best index configuration found so far. Early stopping checks are performed to identify a predetermined characteristic of the index tuning curve to determine if early stopping verification should be performed. A difference between the workload lower bound and the workload upper bound is compared to a threshold when the predetermined characteristic is detected. What-if calls for the workload are terminated based at least in part on the comparison between the difference between the workload lower bound and the workload upper bound and the predefined threshold.

### BACKGROUND

A database management system (DBMS) manages the storage of the data in the database and processes data manipulation statements or queries. Such statements and queries are processed, for example, to retrieve, update, insert, and/or delete data in a database. Queries are defined by a query language supported by the DBMS. For example, users can write queries and run them against a database to retrieve desired information from the database. In general, to retrieve requested information, a database server can retrieve an appropriate table from storage, load it into memory, and search row by row for the desired information. However, given the substantial size of most databases, searching for data in this manner is often time-consuming and inefficient.

To enhance performance in processing queries, a DBMS uses indexes to help access data in a database more efficiently. The number of possible indexes over a database can be very large and can significantly increase the memory requirements, including storage requirements, for the database, as well as the cost associated with keeping the indexes up to date as data is updated, inserted, and deleted. Also, many of the possible indexes may provide no or minimal performance advantage considering the data in the database, the organization of the data in the database, and the usage of the database as represented by a workload of queries executed against the database. Typical database systems therefore use only a subset of possible indexes for accessing databases.

Index tuning is used in selecting and creating indexes. The goal of index tuning is to improve the performance of the database, e.g., by reducing the query processing time. Given a workload (e.g., a set of SQL statements that execute against a database) and a set of constraints (e.g., a storage budget), index tuning tools recommend a set of appropriate indexes to use to improve the performance of the database. Given an input workload, index tuning tools first generate candidate indexes for each query and then search for the best configuration among the candidate indexes via configuration enumeration tool. During enumeration, what-if optimizer calls are made to estimate the cost of a given query-index configuration pair without building the indexes. A what-if call is at least as expensive as a regular optimizer call, consuming a significant (over 70%) fraction of the tuning time. Thus, making a large number of what-if calls increases the time taken for tuning, and increases the CPU and memory burden on the DBMS. The latter is particularly important in cloud databases that offer self-tuning capabilities. For index tuning tools to be scalable, it is therefore important to employ techniques for identifying when what-if calls can be avoided without affecting the quality of recommended indexes.

The larger the workload, the more time it takes for tuning and the more resources required to implement and maintain the tuning. Therefore, one challenge in implementing index tuning tools is scaling these tools to a large workload. The scalability challenge is further amplified today in today's cloud computing environment where the tuning tools need to explore a large number of queries and potential index configurations, which further adds to the resource and cost overheads of the cloud computing environments.

Different approaches have been developed to address the salability problem of index tuning. One approach is enumerating configurations in reduced search spaces. However, this approach still requires one what-if call for every (query, configuration) pair which can still place a burden on the system. This approach may also adversely impact the quality of recommended indexes because in some cases the indexes not considered may offer better results. Another approach is to use cost-derivation techniques to reduce optimizer calls for a subset of (query, index configuration) pairs. Although such techniques help reduce the tuning time, the number of optimizer calls may still be large and therefore may still require a significant amount of tuning time. Furthermore, rules applied for cost derivation may not effectively capture the interactions between multiple indexes, thereby degrading the quality of recommended indexes especially over complex workloads.

What is needed are systems and methods for index tuning that are capable of reducing the number of optimizer calls required to determine a recommended index configuration so that index tuning can be scaled to larger and/or more complex databases workloads.

### SUMMARY

In one general aspect, the instant disclosure presents a data processing system having a processor and a memory in communication with the processor wherein the memory stores executable instructions that, when executed by the processor alone or in combination with other processors, cause the data processing system to perform multiple functions. The functions include receiving a workload to be performed on a database at a database management system (DBMS) for the database, the workload including a plurality of queries; generating a set of candidate indexes for performing the workload using a candidate index generating component of the DBMS; performing an index tuning process using a configuration enumeration component of the DBMS to select a recommended index configuration to use to execute the queries in the workload. The configuration enumeration component is configured to: use a configuration enumeration algorithm to identify index configurations from the set of candidate indexes for each query in the workload that can potentially improve performance of the DBMS in processing the workload; make what-if calls to a query optimizer of the DBMS with query-index configuration pairs to determine what-if costs for the query-index configuration pairs; and select the recommended index configuration based on the determined what-if costs for the query-index configuration pairs. The functions also include deriving a workload lower bound and a workload upper bound on what-if cost for an index tuning curve for the workload using an early stopping checker (ESC) component of the DBMS, the index tuning curve representing a function that maps a number of what-if calls allocated at time t to the index tuning process for the workload to a percentage improvement of a best index configuration found so far during the index tuning process, the workload upper bound at a time point t corresponding to a derived what-if cost for the workload based on an index configuration found by the configuration enumerator at time point t after t what-if calls have been allocated, the workload lower bound being derived from a sum of marginal cost improvement (MCI) upper bounds for a predetermined number of indexes with a largest MCI upper bound; performing an early stopping check at a current time point to determine when early stopping of the index tuning process should be invoked. The early stopping check includes determining an improvement rate for the what-if cost of the workload at a current time point, the improvement rate being determined with reference to a gap between the upper bound and the lower bound for the index tuning curve at the current time point using the ESC component; comparing the improvement rate to a predefined improvement rate threshold using the ESC component to identify an early stopping point for the index tuning process; and causing the configuration enumeration component to end the index tuning process before all budgeted what-if calls have been performed in response to the early stopping point being identified; and continuing to perform early stopping checks until the early stopping point is identified in response the early stopping point not being identified at the current time point.

In yet another general aspect, the instant disclosure presents a method of performing index tuning with early stopping for a database includes receiving a workload to be performed on a database at a database management system (DBMS) for the database, the workload including a plurality of queries; generating a set of candidate indexes for performing the workload using a candidate index generating component of the DBMS; performing an index tuning process using a configuration enumeration component of the DBMS to select a recommended index configuration to use to execute the queries in the workload. The configuration enumeration component is configured to: use a configuration enumeration algorithm to identify index configurations from the set of candidate indexes for each query in the workload that can potentially improve performance of the DBMS in processing the workload; make what-if calls to a query optimizer of the DBMS with query-index configuration pairs to determine what-if costs for the query-index configuration pairs; and select the recommended index configuration based on the determined what-if costs for the query-index configuration pairs. The method also includes deriving a workload lower bound and a workload upper bound on what-if cost for an index tuning curve for the workload using an early stopping checker (ESC) component of the DBMS, the index tuning curve representing a function that maps a number of what-if calls allocated at time t to the index tuning process for the workload to a percentage improvement of a best index configuration found so far during the index tuning process, the workload upper bound at a time point t corresponding to a derived what-if cost for the workload based on an index configuration found by the configuration enumerator at time point t after t what-if calls have been allocated, the workload lower bound being derived from a sum of marginal cost improvement (MCI) upper bounds for a predetermined number of indexes with a largest MCI upper bound; performing an early stopping check at a current time point to determine when early stopping of the index tuning process should be invoked. The early stopping check includes determining an improvement rate for the what-if cost of the workload at a current time point, the improvement rate being determined with reference to a gap between the upper bound and the lower bound for the index tuning curve at the current time point using the ESC component; comparing the improvement rate to a predefined improvement rate threshold using the ESC component to identify an early stopping point for the index tuning process; causing the configuration enumeration component to end the index tuning process before all budgeted what-if calls have been performed in response to the early stopping point being identified; and continuing to perform early stopping checks until the early stopping point is identified in response the early stopping point not being identified at the current time point.

An index tuner for a database management system (DBMS) includes a workload parsing/analysis component configured to receive a workload to be performed on a database, the workload including a plurality of queries; a candidate index generating component configured to generate a set of candidate indexes for performing the workload; a configuration enumeration component configured to: use a configuration enumeration algorithm to identify index configurations from the set of candidate indexes for each query in the workload that can potentially improve performance of the DBMS in processing the workload; make what-if calls to a query optimizer of the DBMS with query-index configuration pairs to determine what-if costs for each of the query-configuration pairs, each of the query-configuration pairs including a query and an index configuration enumerated for the query; and combine the enumerated index configurations having a lowest what-if cost for each query in the workload to form a recommended index configuration for the DBMS to use to for the workload; and an early stopping checker (ESC) component configured to: monitor the what-if costs of the query-configuration pairs; derive a workload lower bound and a workload upper bound on what-if cost for an index tuning curve for the workload as the what-if calls are being made, the index tuning curve representing a function that maps a number of what-if calls allocated at time t to a percentage improvement of a best index configuration found so far; perform at least one early stopping check as the what-if calls are being made based on at least one characteristics of the index tuning curve to determine if early stopping verification should be performed; determine a difference between the workload lower bound and the workload upper bound and compare the difference to a predefined threshold when the at least one early stopping check indicates that early stopping verification should be performed; and alert the configuration enumeration component to stop making the what-if calls based at least in part on the comparison between the difference between the workload lower bound and the workload upper bound and the predefined threshold.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject of this disclosure is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIGS. 1A and 1B show examples of index tuning curves of two-phase greedy search and Monte Carlo tree search (MCTS).

FIG. 2 is a shows an example computing environment in which aspects of the disclosure may be implemented.

FIG. 3 depicts an example implementation of an index tuning system for the DBMS of FIG. 1

FIGS. 4A and 4B show diagrams depicting greedy search and two-phase greed search, respectively.

FIG. 5 is a graph of a framework for early-stopping in budget-aware index tuning based on workload-level bounds of what-if cost.

FIG. 6 shows parameters for an example of index interaction.

FIGS. 7A and 7B show the relationship between pairwise index interaction and pairwise index similarity (TPC-H) for the two most costly queries of TPC-H.

FIG. 8 is a graph showing the relationship between different definitions of index tuning curves.

FIG. 9 is a graph showing the relationship between improvement rates and convexity concavity for an example index tuning curve.

FIGS. 10A-10D show the extra time overhead (in minutes) of early-stopping verification, the improvement loss when early-stopping is triggered, the savings on the number of what-if calls, and the index tuning curve as well as the corresponding lower and upper bounds when running two-phase greedy search on top of TPC-H.

FIGS. 11A-11D show the extra time overhead (in minutes) of early-stopping verification, the improvement loss when early-stopping is triggered, the savings on the number of what-if calls, and the index tuning curve as well as the corresponding lower and upper bounds when running two-phase greedy search on top of TPC-DS.

FIGS. 12A-12D show the extra time overhead (in minutes) of early-stopping verification, the improvement loss when early-stopping is triggered, the savings on the number of what-if calls, and the index tuning curve as well as the corresponding lower and upper bounds when running two-phase greedy search on top of Real-D.

FIGS. 13A-13D show the extra time overhead (in minutes) of early-stopping verification, the improvement loss when early-stopping is triggered, the savings on the number of what-if calls, and the index tuning curve as well as the corresponding lower and upper bounds when running MCTS on top of TPC-H.

FIGS. 14A-14D show the extra time overhead (in minutes) of early-stopping verification, the improvement loss when early-stopping is triggered, the savings on the number of what-if calls, and the index tuning curve as well as the corresponding lower and upper bounds when running MCTS on top of Real-D.

FIGS. 15A-15D show the extra time overhead (in minutes) of early-stopping verification, the improvement loss when early-stopping is triggered, the savings on the number of what-if calls, and the index tuning curve as well as the corresponding lower and upper bounds when running two-phase greedy search with Wii coverage on top of Real-M.

FIGS. 16A-16D show comparison of two-phase greedy (TPG) search with ESC (without or with what-if call interception) against DTA for workloads JOB, TPC-DS, Real-D, and Real-M, respectively.

FIG. 17 is a flowchart of an example method for index tuning including early stopping checking and verification.

FIG. 18 is a block diagram of an example computing device, which may be used to provide implementations of the mechanisms described herein; and

FIG. 19 is a block diagram illustrating components of an example machine configured to read instructions from a machine-readable medium

### DETAILED DESCRIPTION

As noted above, index tuning is a time-consuming process that may take hours to finish for large and complex workloads. Existing index tuners typically adopt a cost-based tuning architecture for index tuning. It consists of three main components: (1) workload parsing and analysis, which parses each query in the workload and extracts indexable columns, e.g., columns that appear in selection and join predicates; (2) candidate index generation, which puts together the extracted indexable columns to generate a set of indexes that can potentially reduce the execution cost of the input workload; and (3) configuration enumeration, which looks for a subset (a.k.a., configuration) from the candidate indexes that meets the input constraints (e.g., maximum configuration size or amount of storage to be taken by the indexes) while minimizing the input workload cost.

To evaluate the cost of a given query and configuration pair, index tuners rely on the so-called “what-if” utility. It is an extended API of the query optimizer that can estimate the cost by viewing the indexes contained by the configuration as “hypothetical indexes” instead of materializing them in a storage system, which would be much more costly. Nevertheless, what-if optimizer calls are not free; they are at least as expensive as a regular query optimizer call. As a result, they become the major bottleneck when tuning large and/or complex workloads.

To address this challenge, some technologies have been developed, such as cost derivation, caching/reusing what-if calls that requires code changes to the query optimizer beyond the what-if API, or ML-based cost approximation. Recent research has proposed budget-aware index tuning, which constrains the number of what-if calls allowed during configuration enumeration. Here, the main challenge shifts from reducing the number of what-if calls as in classic index tuning to prioritizing what-if calls with respect to the importance of query-configuration pairs in budget-aware index tuning. This problem is termed as budget allocation.

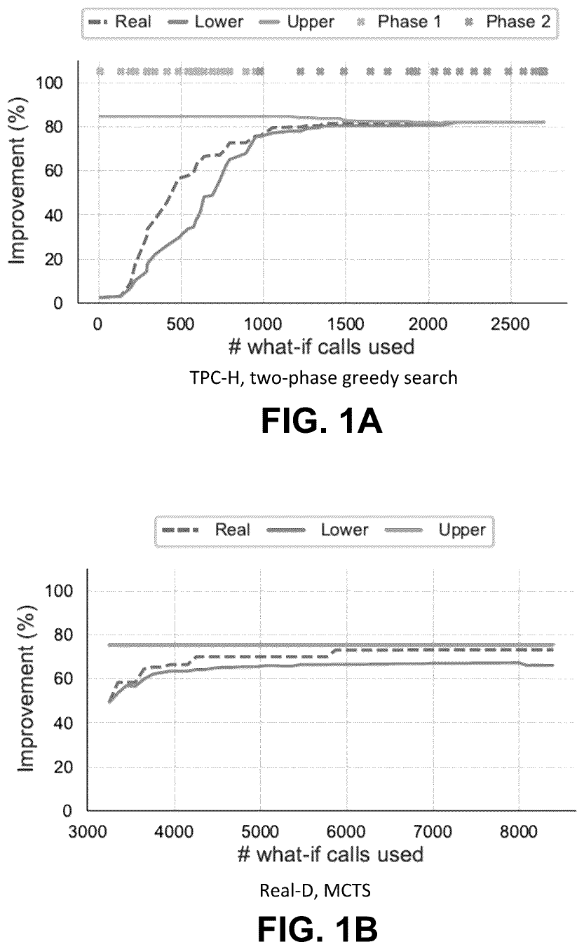

A “diminishing return” behavior has been observed in existing budget-aware index tuning algorithms. The percentage improvement exhibited by existing budget-aware index tuning algorithms is typically high at the beginning of the process but slows down as more budget on what-if calls is allocated. To put this into context, FIGS. 1A and 1B show examples of index tuning curves (ITCs) when using two state-of-the-art budget-aware index tuning algorithms, namely, two-phase greedy search and (MCTS), respectively. In FIG. 1A, two-phase greedy search is used to tune a standard a benchmark workload TPC-H, and, in FIG. 1B, MCTS is used to tune a real customer workload Real-D. In these examples, the number of indexes allowed K was set to 20 and the budget on what-if calls B was set to 20,000. The ITCs are represented by a function that maps the number of what-if calls allocated to the percentage improvement of the best configuration found, where the percentage improvement is defined as

$$η ( W , C ) = \frac{c ( W , ∅ ) - c ( W , C )}{c ( W , ∅ )} = 1 - \frac{c ( W , C )}{c ( W , ∅ )} . \qquad ( 1 )$$

Here, W Represents the Input Workload, C Represents a Configuration, and Ø Represents the Existing Configuration that Index Tuning Starts from. The Equation

$$c ( W , C ) = {\sum }_{q ∈ W} c ( q , C )$$

represents the what-if cost of the workload W on top of the configuration C, which is the sum of the what-if costs of individual queries contained by W. In each plot of FIGS. 1A and 1B, the dashed line is used to represent the ITC. As can be seen, each ITC characterizes the performance of the index tuner based on the progress made in performance or cost improvements with respect to the amount of budget (what-if calls) being allocated.

This “diminishing return” behavior of existing budget-aware index tuning algorithms enables by identifying a point in the ITC additional gains in the percentage improvement that may result from making additional what-if calls are below a predetermined threshold € (e.g., ∈=5%). To think of this another way, e defines difference, or gap, between the percentage improvement of the best configuration found so far and the percentage improvement of the final best configuration with all of the what-if call budget allocated. If the projected gap is below e after certain amount of what-if calls are made, then index tuning can be terminated. Early stopping enables savings on the number of what-if calls made in index tuning that would otherwise be made if early stopping was not invoked, and these savings can often be considerable. For example, as shown in FIG. 1A, two-phase greedy search requires making around 2,700 what-if calls to tune the TPC-H workload without early stopping. However, it actually makes no further progress (i.e., the best index configuration found does not change) after 1,000 what-if calls are made. Therefore, 1,700 what-if calls would be saved, which corresponds to a reduction of 63%.

Enabling early stopping for budget-aware index tuning raises two challenges which must be addressed. First, to project the gap that is required to trigger early stopping, two parameters are needed: (1) the percentage improvement of the best configuration found so far (i.e., the first percentage improvement) and (2) the percentage improvement of the final best configuration assuming that all budget were allocated (i.e., the second percentage improvement). The true values for these parameters are not available at the time point where the projection needs to be made. For instance, the second percentage improvement cannot be known until all budgeted what-if calls have been processed. It would be possible to obtain the first percentage improvement by making an extra what-if call for each query in the workload with the best configuration found, but this is too expensive in practice when tuning a large workload. Therefore, the first and second percentage improvement values must be derived from other parameters (explained in more detail below). Second, even if the first and second percentage improvement values are known, an optimum time for verifying whether the gap between them is less than the threshold ∈ must be determined so that early stopping is not performed too early when additional improvements are possible or too late when the savings given by early stopping are reduced.

To address the first challenge, instead of measuring the first percentage and the second percentage, which cannot be obtained in practice, a lower-bound is developed to represent the first percentage and an upper-bound is developed to represent the second percentage. The gap between the lower and upper bounds can then be measured for comparison with the gap threshold E. FIGS. 1A and 1B also show the lower and upper bounds for each ITC. To address the second challenge, a general approach is developed that performs early-stopping verification by monitoring the improvement rate of the ITC. More specifically, the degree of convexity/concavity of the ITC is monitored which is indicative of the improvement rate, and verification is performed to determine whether the current gap is less than the gap threshold e when the ITC is concave (explained in more detail below).

The lower and upper bounds of percentage improvement are workload-level bounds. To derive these bounds, a process for determining lower and upper bounds per what-if call is extended to workloads. A straightforward approach that simply sums up call level bounds would lead to workload-level bounds that are too conservative to be useful. Based on this observation, the following mechanisms are provided which offer improvements over the straightforward approach: (i) a simulated greedy search procedure that is designed for optimizing the bounds in the context of greedy search, and (ii) a generic approach to refining the bounds by modeling index interactions at workload-level. There can be multiple concave stages of an ITC, but only the final concave stage is worth early-stopping verification. An example of this final stage is shown by FIG. 1B. In the example, the final stage of the ITC begins after 6,000 what-if calls are made. It is challenging to identify whether a concave stage is the final one. Therefore, additional techniques are provided to address this challenge in order to reduce the chance of unnecessary early-stopping verification.

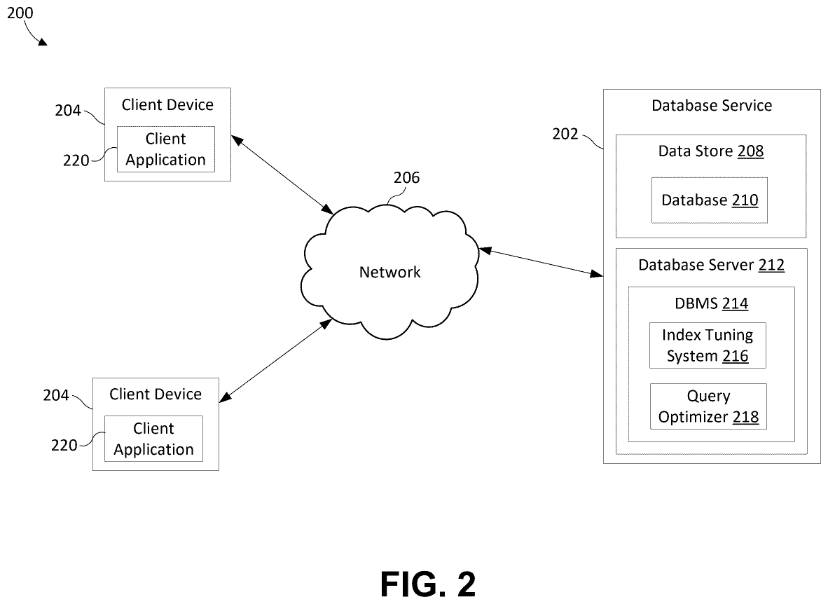

FIG. 2 shows an example computing environment 200 upon which aspects of this disclosure may be implemented. Computing environment 200 includes a database service 202 and client devices 204 which communicate with each other via a network 206. The network 206 includes one or more wired, wireless, and/or a combination of wired and wireless networks. In embodiments, the network 206 includes one or more local area networks (LAN), wide area networks (WAN) (e.g., the Internet), public networks, private networks, virtual networks, mesh networks, peer-to-peer networks, and/or other interconnected data paths across which multiple devices may communicate.

The database service 202 is implemented as a cloud-based service or set of services which provides data storage, access, management, and/or security for customers. To this end, database service 202 includes a data store 108. The data store 208 comprises one or more storage devices that provide a non-volatile storage volume. A database 210 is implemented in the data store 208. The database 210 organizes data for the database service in a set of tables. Each table is defined by one or more rows which represent records and one or more columns which represent data fields. Program code, instructions, user data and/or content for the database service 202 may also be stored in the data store 208.

Database service 202 includes at least one database server 212 which provides computational resources for implementing the database service 202. The database server 212 is representative of any physical or virtual computing system, device, or collection thereof, such as, a web server, rack server, blade server, virtual machine server, or tower server, as well as any other type of computing system. In embodiments, the database server 212 is implemented in a data center, a virtual data center, or some other suitable facility. Database server 212 executes one or more software applications, modules, components, or combinations thereof capable of providing the database service to clients, such as client devices 204. The software applications include a database management system (DBMS) 214 for managing the database 210 and processing queries, for example, to retrieve, insert, delete, and/or update data in database 210. DBMS 214 supports any suitable database query language, such as Structured Query Language (SQL). Although a single server 212 and data store 208 are shown in FIG. 2, database service 202 can utilize any suitable number of servers and/or data stores.

The client devices 204 enable users to connect to the database service 202 and access the database 210. Client devices 204 are computing devices that may be implemented as a portable electronic device, such as a mobile phone, a tablet computer, a laptop computer, a portable digital assistant device, a portable game console, and/or other such devices. Client devices 204 include a client application 220 that is capable of communicating with DBMS 214 via the network 206. In embodiments, client applications 220 include a user interface that enables users to input database queries for processing by the DBMS 214.

DBMS 214 includes an index tuning system 216 and a query optimizer 218. The index tuning system 216 receives an input workload (i.e., a set of database queries) to be executed and generates a set of candidate indexes to use to perform each query in the workload. The index tuning system 216 then enumerates possible index configurations (i.e., subsets of candidate indexes) from the set of candidate indexes to use in executing each query. The goal of index tuning is to improve the performance of the database, e.g., by reducing the query processing time. The index tuning system 216 is designed to implement a cost-based index tuning scheme. To this end, what-if optimizer calls are made to the query optimizer 218 during enumeration to estimate the cost of each query-index configuration pair without building the indexes. The index configurations for each query having the lowest cost are selected to form a recommended set of indexes for the DBMS 214 to use in executing the queries in the workload.

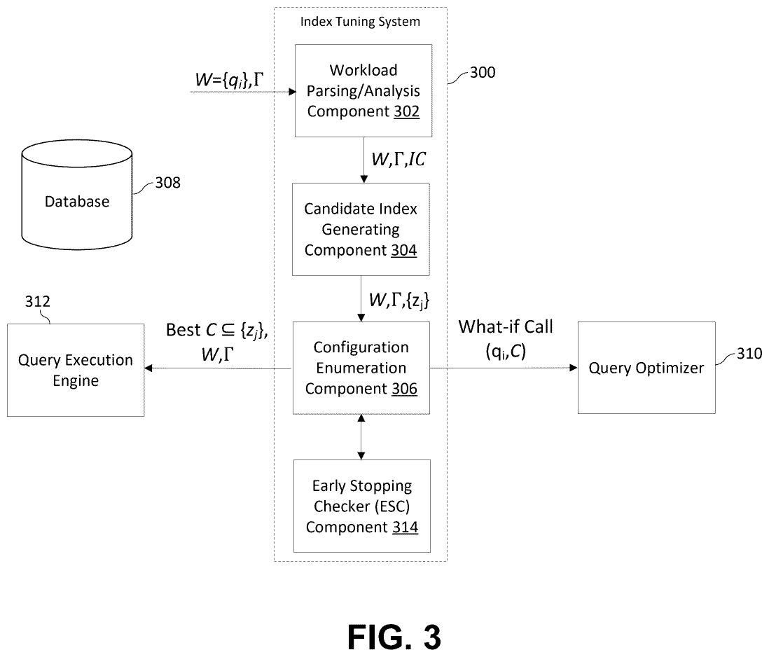

As noted above, making what-if optimizer calls is time consuming and resource intensive. To enable index tuning to be scalable, the index tuning system 216 is configured to implement a budget aware early stopping scheme capable of identifying when what-if calls can be avoided without affecting the quality of recommended indexes. An example implementation of an index tuning system 216 with budget aware early stopping is shown in in FIG. 3. The index tuning system 300 of FIG. 3 includes a workload parsing/analysis component 302, a candidate index generating component 304, and a configuration enumeration component 306. Index tuning system 300 is configured to receive as input a workload W and predefined constraints I, such as maximum number of indexes allowed and storage budget. The workload W is a set of queries (W={qᵢ}), such as SQL statements, to be executed on a database 308. The workload parsing/analysis component 302 parses each query in the workload(qᵢ∈W) and identifies the indexable columns IC in the database which are pertinent to each query, such as columns that appear in selection and join predicates. The candidate index generating component 304 then combines the extracted indexable columns IC based on predefined rules to generate a set of candidate indexes {zⱼ} that can potentially reduce the execution cost of the input workload.

The configuration enumeration component 306 is configured to process the set of candidate indexes {zⱼ} with respect to the queries in the workload to determine a recommended set of indexes (Best C⊂{zⱼ}) for the workload W that meets the input constraints Γ (e.g., maximum configuration size or amount of storage to be taken by the indexes) while minimizing the input workload cost. To determine the workload cost, the configuration enumeration component 306 makes “what-if” calls to a query optimizer 310 with query-configuration pairs (qᵢ, C) for each query in the workload. The query optimizer 310 is configured to process the what-if calls by viewing the indexes contained by the index configuration C as “hypothetical indexes” instead of materializing them in the storage system. The cost may correspond to an estimate of the amount of resources, such as CPU, I/O, and memory, required to execute the query, the amount of time required to execute the query, and/or based on other type of statistical information.

The configuration enumeration component 306 is configured to enumerate multiple possible index configurations that are capable of handling a given query. What-if calls are then made for each enumerated index configuration for each query so that the index configuration that results in the lowest cost can be identified for each query. The index configurations that result in the lowest cost for each query in the workload are then combined to form the recommended set of indexes (Best C⊂{zⱼ}) to use for the workload. The recommended set of indexes is then provided to a query execution engine 312 to use in executing the queries of the workload.

What-if calls are at least as expensive as regular optimizer calls in regard to time and resource usage. Therefore, index tuning can be a time consuming and resource intensive process. As the number of what-if calls increases, the time and resources required for index tuning also increases. The cost of index tuning can therefore become prohibitively high as the size and/or complexity of database systems increase. To enable to the index tuning system of FIG. 3 to be scalable to large and complex database systems, the index tuning system 300 includes an early-stopping checker (ESC) component 314 which generates an index tuning curve (ITC) (explained in more detail below) that represents a function that maps what-if calls allocated to a percentage improvement of the corresponding best index configuration found so far. The ESC component 314 analyzes the ITC to identify an early stopping point for the what-if calls allocated to the workload. When the early stopping point is identified, allocation of what-if calls to the workload can be terminated.

Budget-aware index tuning aims to constrain the amount of what-if calls that can be made during index tuning, in particular, during index configuration enumeration. An essential problem of budget-aware index tuning is budget allocation, i.e., determining on which query-configuration pairs to make what-if calls. For any query-configuration pair, a derived cost can be determined as an approximation of its true what-if cost without making what-if call using the following equation:

$$d ( q , C ) = {min}_{S ⊆ C} c ( q , S ) , \qquad ( 2 )$$

There are Two Existing Algorithms that Address this Budget Allocation Problem: (1) Two-Phase Greedy Search and (2) Monte Carlo Tree Search (MCTS).

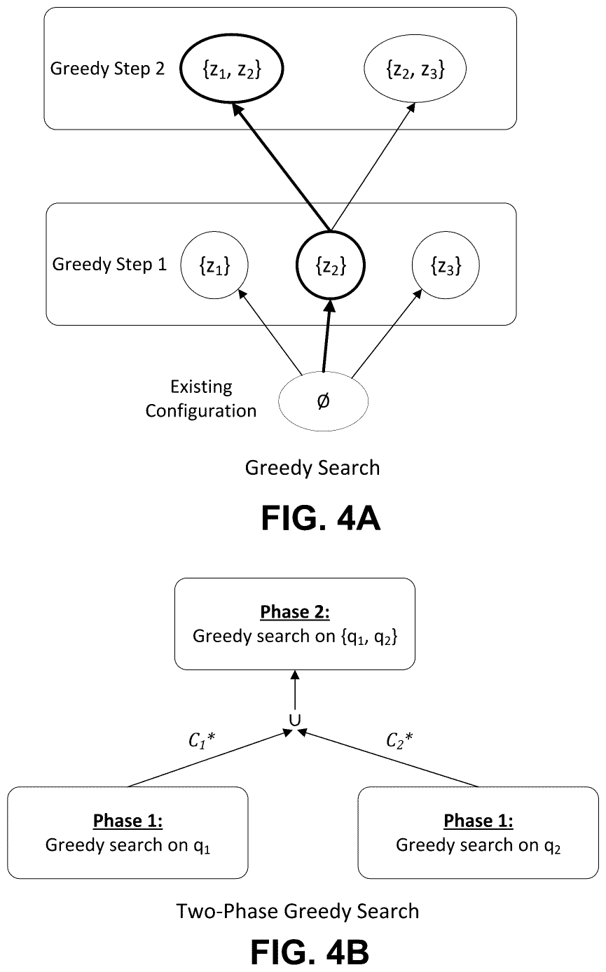

Referring to FIG. 4A, greedy search is a step-by-step procedure where the algorithm selects the next best candidate index in each greedy step that minimizes the workload cost, until the selected index configuration meets the given constraints. An improved version is the so-called two-phase greedy search, which first runs greedy search on top of each query to find its best candidate indexes and then runs greedy search again for the entire workload by taking the union of the best candidate indexes found for the individual queries. FIG. 4B presents an example of two-phase greedy search with two queries in the workload. What-if calls are allocated in a “first come first serve” manner. Two-phase greedy search can achieve state-of-the-art performance in terms of the final index configuration found and has also been integrated into commercial database tuning software such as the Database Tuning Advisor (DTA) developed for Microsoft SQL Server.

A budget-aware index tuning algorithm based on MCTS is capable of handling the trade-off between exploration and exploitation in budget allocation. It models budget allocation as a Markov decision process (MDP) and allocates what-if calls with the goal of maximizing the “reward” that is defined by the percentage improvement (See, Equation 1). After budget allocation is done, a greedy search is ran again to find the best index configuration with the lowest derived cost (See, Equation 2). It has been shown that MCTS can outperform two-phase greedy search under limited budget on what-if calls in certain situations.

The two budget-aware index tuning algorithms mentioned above allocate what-if calls at a macro level by treating each what-if call as a black box. That is, they use the what-if cost, which in this case is an approximation, or derived cost, as the only signal to decide the next what-if call to be made. This results in wasted budget on inessential what-if calls that can be accurately approximated by their derived costs without affecting the result of index tuning. To skip these inessential what-if calls, a what-if call interception mechanism referred to as Wii can be used that enables dynamic budget allocation in index tuning. The main idea is to use lower and upper bounds of what-if cost to determine whether a what-if call can be skipped. In budget-constrained index tuning, skipping these inessential what-if calls can sharpen the efficacy of budget allocation by reallocating the budget to what-if calls that cannot be skipped. This results in improved versions of two-phase greedy search and MCTS algorithms.

To formulate the problem of early stopping in budget-aware index tuning, let B be the budget on the number of what-if calls. At time t when t what-if calls have been allocated, it must be determined if it is safe to skip allocating the remaining B−t what-if calls without much loss on the improvement of the final index configuration returned. Formally, let

$${C}_{t}^{*}$$

be the configuration found with t≤B what-if calls allocated. That is, after t what-if calls, only derived cost can be used when running the remaining part of configuration search. Under this notation,

$${C}_{B}^{*}$$

is the configuration found with all B what-if calls allocated. Index tuning can be stopped if

$$η ( W , {C}_{B}^{*} ) - η ( W , {C}_{t}^{*} ) \leq ϵ , \qquad ( 3 )$$

where 0<∈<1 is a user-defined threshold. By Equation 1

$$c ( W , {C}_{t}^{*} ) - c ( W , {C}_{B}^{*} ) \leq ϵ \cdot c ( W , ∅ ) . \qquad ( 4 )$$

As noted above, computing the left side of Equation 4 is impossible since

$$c ( W , {C}_{B}^{*} )$$

(i.e., the second percentage improvement) would only be known when all B what-if calls were allocated, which negates the very purpose of early stopping. Moreover, the computation of

$$c ( W , {C}_{t}^{*} )$$

(i.e., the first percentage improvement) would require making |W| extra what-if calls for each time point t, which would be prohibitively expensive for large workloads. As a result, a different approach is needed rather than utilizing Equation 4 directly. This approach involves finding lower and upper bounds to define the gap between

$$c ( W , {C}_{B}^{*} ) and c ( W , {C}_{t}^{*} ) .$$

A Framework is Provided to Enable Development of the Lower and Upper Bounds of Workload-Level What-if Cost. More Specifically, a Lower Bound

$${η}_{L} ( W , {C}_{t}^{*} )$$

is developed for

$$η ( W , {C}_{t}^{*} ) ,$$

and an upper bound

$${η}_{U} ( W , {C}_{B}^{*} )$$

is developed for η(W, C*_{B}), where

$${η}_{L} ( W , {C}_{t}^{*} ) \leq η ( W , {C}_{t}^{*} ) and η ( W , {C}_{B}^{*} ) \leq {η}_{U} ( W , {C}_{B}^{*} ) .$$

As a result, if

$${η}_{U} ( W , {C}_{B}^{*} ) - {η}_{L} ( W , {C}_{t}^{*} ) \leq ϵ$$

(i.e., the gap between the upper and lower bounds is less than or equal to the threshold), it then implies that

$$η ( W , {C}_{B}^{*} ) - η ( W , {C}_{t}^{*} ) \leq ϵ$$

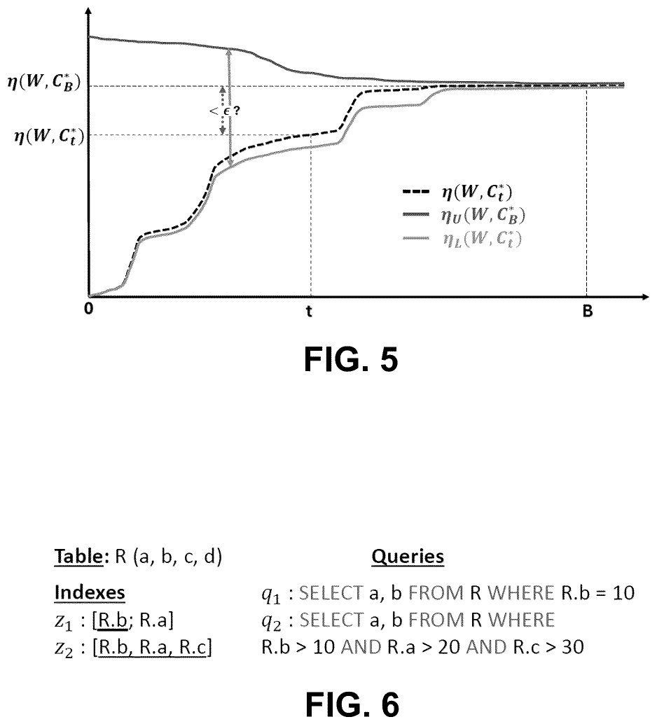

(i.e., Equation 3) indicating that index tuning can be stopped. FIG. 5 illustrates the framework in detail. In FIG. 5, the x-axis represents the number of what-if calls allocated, and the y-axis represents the percentage improvement of the corresponding best configuration found. Ideally, the true percentage improvements

$$η ( W , {C}_{t}^{*} ) and η ( W , {C}_{B}^{*} )$$

should be compared; however, since the true improvements are not observable, the lower and upper bounds

$${η}_{L} ( W , {C}_{t}^{*} ) and {η}_{U} ( W , {C}_{B}^{*} ) ,$$

respectively, are compared, as mentioned above.

To determine the lower and upper bounds on what-if costs, an upper bound

$$U ( W , {C}_{t}^{*} ) \geq c ( W , {C}_{t}^{*} )$$

and a lower bound

$$L ( W , {C}_{B}^{*} ) \geq c ( W , {C}_{B}^{*} )$$

must be determined where

$${η}_{L} ( W , {C}_{t}^{*} ) \leq η ( W , {C}_{t}^{*} ) and {η}_{U} ( W , {C}_{B}^{*} ) \geq η ( W , {C}_{B}^{*} ) .$$

To derive

$$L ( W , {C}_{B}^{*} ) and U ( W , {C}_{t}^{*} ) ,$$

a more fundamental problem is considered: Given an arbitrary configuration C, derive a lower bound L(W, C) and an upper bound U(W, C) such that L(W,C)≤c(W,C)≤U(W,C). Since c(W, C)=Σ_{q∈W}c(q, C), it is natural to first consider call-level lower and upper bounds L(q, C) and U(q, C) for a given query q such that L(q, C)≤c(q, C)≤U(q,C). For this purpose, previously known methods of determining call level bounds may be used.

To develop a call-level upper bound, an assumption is made regarding a monotonicity property of the what-if cost:
Assumption 1 (Monotonicity). Let C₁ and C₂ be two index configurations where C₁⊆C₂. Then c(q, C₂)≤c(q, C₁).
   In other words, monotonicity means that adding more indexes into a configuration does not increase the what-if cost. Based on the monotonicity property, the derived cost d(q, C)≥c(q, C), which is a valid upper bound, i.e., U(q, C)=d(q,C).

To develop the lower bound, the cost improvement of the query q given the configuration C is defined as Δ(q, C)=c(q, Ø)−c(q, C). In addition, the marginal cost improvement (MCI) of an index z with respect to a configuration C is defined as δ(q, z, C)=c(q, C)−c(q, C∪{z}). Let C={z₁, . . . , zₘ}. The cost improvement can now be rewritten in terms of the MCI's, i.e.,

$$Δ ( q , C ) = {\sum }_{j = 1}^{m} δ ( q , {z}_{j} , {C}_{j - 1} ) \leq {\sum }_{j = 1}^{m} u ( q , {z}_{j} ) ,$$

where C₀=Ø, Cⱼ₋₁∪{zⱼ}, and u(q, zⱼ) is an upper bound of the MCI δ(q, zⱼ, Cⱼ₋₁), for 1≤j≤m. As a result, the lower bound L(q, C) can be set as

$$L ( q , C ) = c ( q , ∅ ) - {\sum }_{j = 1}^{m} u ( q , {z}_{j} ) \leq c ( q , C ) . \qquad ( 5 )$$

For the MCI upper bounds, the following assumption regarding the submodularity property of the what-if cost can be made:
Assumption 2 (Submodularity). Given two configurations X and Y such that X⊆Y and an index z∉Y, c(q, Y)−c(q, Y∪{z})≤c(q, X)−c(q, X∪{z}). Or equivalently, δ(q, z, Y)≤δ(q, z, X).
   In other words, the MCI of an index z diminishes when z is included into a larger configuration with more indexes.

It is assumed that cost function c(q,X) has the monotonicity and submodularity properties. Let Ωq be the best possible configuration for q assuming that all candidate indexes have been created. This enables the MCI upper bound to be set as follows:

$$u ( q , z ) = min \{ c ( q , ∅ ) , Δ ( q , {Ω}_{q} ) , Δ ( q , \{ z \} ) \} . \qquad ( 10 )$$

In practice, there are situations where c(q, {z}) and thus Δ(q, {z}) are not known. In some cases, c(q, {z}) can be estimated based on the coverage of {z} with respect to Ωq, assuming that c(q, Ωq) is known.

A method for leveraging the call-level lower and upper bounds on what-if cost to establish workload-level lower and upper bounds will now be described. For general-purpose bounds, the upper bound of workload cost

$$U ( W , {C}_{t}^{*} )$$

can just be set to the derived cost

$$d ( W , {C}_{t}^{*} )$$

since it can be shown that

$$d ( W , C ) = {\sum }_{q ∈ W} d ( q , C ) \geq {\sum }_{q ∈ W} c ( q , C ) = c ( W , C )$$

for an arbitrary index configuration C. To obtain

$${C}_{t}^{*} ,$$

however, the index tuning algorithm must be continued on top of the current best configuration Cₜ found without making more what-if calls.

For the lower bound of workload cost, let

$${C}_{t}^{*} = \{ {z}_{1} , … , {z}_{k} \}$$

for some k≤K. By Equation 8, the lower bound can then be set as follows

$$L ( W , {C}_{B}^{*} ) = {\sum }_{q ∈ W} L ( q , {C}_{B}^{*} ) = {\sum }_{q ∈ W} ( c ( q , ∅ ) - {\sum }_{i = 1}^{k} ( u ( q , {z}_{i} ) ) .$$

Unfortunately, this lower bound cannot be computed directly because

$${C}_{B}^{*}$$

is not known and therefore the {z₁, . . . , zₖ} at time t<B is not known. However, for each query q∈W, if all candidate indexes z are ordered decreasingly with respect to their u(q, z) and then the top K candidate indexes in this ranking are considered, it can be shown that

$${\sum }_{i = 1}^{k} u ( q , {z}_{i} ) \leq {\sum }_{z ∈ 𝒰 ( q , K )} u ( q , z ) ,$$

where [symbol] (q, K) represents the set of candidate indexes of q with the top-K largest MCI upper bounds. Therefore, the lower bound can instead be set to

$$L ( W , {C}_{B}^{*} ) = {\sum }_{q ∈ W} ( c ( q , ∅ ) - {\sum }_{z ∈ 𝒰 ( q , K )} u ( q , z ) ) . \qquad ( 7 )$$

This lower bound can be used for any budget-aware tuning algorithm. However, this lower bound may be too conservative, but there are optimizations which can improve the applicability of the lower bound.

To optimize the lower bound for greedy search, let

$${C}_{B}^{*} = \{ {z}_{1} , … , {z}_{k} \}$$

for some k≤K where zᵢ represents the index selected by greedy search at the i-th step (1<i≤k) with B what-if calls allocated. The lower bound given by applying Equation 8,

$$L ( W , {C}_{B}^{*} ) = {\sum }_{q ∈ W} ( c ( q , ∅ ) - {\sum }_{i = 1}^{k} ( {u}^{( i )} ( q , {z}_{i} ) ) , \qquad ( 8 )$$

cannot be computed. Here, u⁽ⁱ⁾(q, z) is the u(q, z) after the greedy step i. The following procedure can be used to update the MCI upper bounds:
Procedure 1. For each index z that has not been selected by greedy search, we update u(q, z) as follows:
(a) Initialize u(q, z)=min {c(q, Ø), Δ(q, Ω_{g})} for each index z.
(b) During each greedy step 1≤k≤K, update

$$u ( q , z ) = c ( q , {C}_{k - 1} ) - c ( q , {C}_{k - 1} ⋃ \{ z \} ) = δ ( q , z , {C}_{k - 1} )$$

if both c(q, Cₖ₋₁) and c(q, Cₖ₋₁∪{z}) are available, where Cₖ is the configuration selected by the greedy step k and C₀=Ø.

The idea is to develop an upper bound for

$${\sum }_{i = 1}^{k} ( {u}^{( i )} ( q , {z}_{i} )$$

by running a simulated greedy search procedure as described below. Consider tuning a workload with a single query q using greedy search. The simulated greedy search procedure can be defined as:
Procedure 2. At time t (i.e., when t<B what-if calls have been made), run greedy search to get up to K indexes in total, where each greedy step j selects the index

$${z}_{j}^{′}$$

with the maximum

$${u}^{( j )} ( q , {z}_{j}^{′} ) > 0 .$$

Let the configuration found by Procedure 2 be

$${C}_{t}^{u} = \{ {z}_{1}^{′} , {z}_{2}^{′} , … , {z}_{l}^{′} \}$$

where l≤K. If l<K, then it means that any remaining index z satisfies u(q, z)=0. As a result, it can be assumed that l=K. This enables the following theorem to be defined as:

$$THEOREM 1.$$

$${\sum }_{j = 1}^{K} {u}^{( j )} ( q , {z}_{j}^{′} ) \geq {\sum }_{i = 1}^{K} {u}^{( i )} ( q , {z}_{i} ) . \\ As a result , \\ L ( q , {C}_{B}^{*} ) = c ( q , ∅ ) - {\sum }_{j = 1}^{K} {u}^{( j )} ( q , {z}_{j}^{′} ) \qquad ( 9 )$$

is a lower bound of the what-if

$$cost c ( q , {C}_{B}^{*} )$$

for greedy search.
This result can be generalized to multi-query workloads with the understanding that the index

$${z}_{j}^{′}$$

is selected for the entire workload W with the maximum

$${u}^{( j )} ( W , {z}_{j}^{′} ) > 0 , i . e . , L ( W , {C}_{B}^{*} ) = c ( W , ∅ ) - {\sum }_{j = 1}^{K} {u}^{( j )} ( W , {z}_{j}^{′} ) , \\ where \\ u ( W , z ) = {\sum }_{q ∈ W} u ( q , z ) . \qquad ( 10 )$$

The MCI upper-bounds can be updated for two-phase greedy search using the following procedure:
Procedure 3. For index z and query q, update u(q, z) as follows:
(a) Initialize u(q, z)=min {c(q, Ø), Δ(q, Ω_{q})} for each index z.
(b) In Phase 1, update u(q, z) based on Equation 6.
(c) In Phase 2, during each greedy step 1≤k≤K, update

$$u ( q , z ) = c ( q , {C}_{k - 1} ) - c ( q , {C}_{k - 1} ⋃ \{ z \} ) = δ ( q , z , {C}_{k - 1} )$$

if both c (W, Cₖ₋₁) and c(q, Cₖ₋₁∪{z}) are available, where Cₖ is the configuration selected by greedy search in step k (C₀=Ø) and z has no been included in Cₖ.
   The update step (c) excludes pathological cases where c (W,Cₖ) is unknown but both c (q,Cₖ) and c(q,Cₖ∪{z}) are known for a particular query q (due to Phase 1).

Procedure 3 enables the following theorem to be defined as follows:
Theorem 2. The

$$L ( W , {C}_{B}^{*} )$$

defined in Equation 14 remains a lower bound of

$$c ( W , {C}_{B}^{*} ) )$$

for two-phase greedy search if we maintain the MCI upper-bounds by following Procedure 3.
For a lower bound for MCTS, the same simulated greedy search used to obtain

$$L ( W , {C}_{B}^{*} )$$

can be used given that there is a final greedy search stage in MCTS after all budget allocation is done. In this case, Equation 6 can be used for maintaining the MCI upper bounds.

The approach described above for computing the lower bounds

$$L ( q , {C}_{B}^{*} ) and L ( W , {C}_{B}^{*} )$$

in Equations 9 and 10 basically sums up the MCI upper bounds of individual indexes. This ignores potential index interactions, as illustrated by the following example.
Example 1 (Index Interaction). As shown in FIG. 6, let R be a table with four columns a, b, c, and d. Let z1 and z2 be two indexes on R, where z1 has a single key column b with a as an included column, and z2 has a compound key with three columns b, a, and c in order. Consider the SQL query q1 in FIG. 6. Both z₁ and z₂ have very similar, if not the same, cost improvement for q1, as one can use an index scan on top of either z₁ and z₂ to evaluate q1 without consulting the table R. As a result, if z₁ (resp. z₂) has been included in some configuration, including z₂ (resp. z₁) cannot further improve the cost of q₁. In other words, we the cost improvements for z₁, z₂, and {z₁, z₂}, i.e., Δ(q₁, {z₁})≈Δ(q₁, {z₂})≈Δ(q₁, {z₁, z₂}) the same.

Note that index interaction is query-dependent. To see this, consider the same z1 and z₂ in Example 1 but a different SQL query q₂ from FIG. 6. Since z₁ cannot be used for evaluating q₂, Δ(q₂, {z₁})≈0. As a result, in the presence of both z₁ and z₂, the query optimizer will pick z₂ over z₁; hence, Δ(q₂, {z₁, z₂})=Δ(q₂, {z₂})≈Δ(q₂, {z₁})+Δ(q₂, {z₂}). Therefore, z₁ and z₂ do not interact in the case of q₂.

Motivated by Example 1, given two indexes z₁, z₂ and a query q, the index interaction between z₁ and z₂ with respect to q is defined as

$$I ( {z}_{1} , {z}_{2} \vert q ) = \frac{{Δ}_{U} ( q , \{ {z}_{1} , {z}_{2} \} ) - Δ ( q , \{ {z}_{1} , {z}_{2} \} )}{{Δ}_{U} ( q , \{ {z}_{1} , {z}_{2} \} ) - {Δ}_{L} ( q , \{ {z}_{1} , {z}_{2} \} )} .$$

Here, Δ_{L}(q, {z₁, z₂})=max{Δ(q, {z₁}), Δ(q, {z₂})} is a lower bound of Δ(q, {z₁, z₂}) based on Assumption 1 (i.e., monotonicity), and Δ_{∪}(q, {z₁, z₂})=Δ(q, {z₁})+Δ(q, {z₂}) is an upper bound of Δ(q, {z₁, z₂}) based on Assumption 2 (i.e., submodularity).

The above definition can now be extended to define the interaction between an index z and an index configuration C with respect to a query q as follows:

$$I ( z , C \vert q ) = \frac{{Δ}_{U} ( q , C ⋃ \{ z \} ) - Δ ( q , C ⋃ \{ z \} )}{{Δ}_{U} ( q , C ⋃ \{ z \} ) - {Δ}_{L} ( q , C ⋃ \{ z \} )} .$$

Similarly, Δ_{L}(q, C∪{z})=max {Δ(q, C), Δ(q, {z})} is a lower bound of Δ(q, C∪{z}) (by Assumption 1) and Δ_{∪}(q, C∪{z})=Δ(q, C)+Δ(q, {z}) is an upper bound of Δ(q, C∪{z}) (by Assumption 2).

Note that the interaction I(z₁, z₂|q) cannot be directly computed without knowledge about Δ(q, C) and Δ(q, C∪{z}). Therefore, this disclosure provides an implicit approach to measure index interaction based on the similarity between indexes. Intuitively, if two indexes are similar, e.g., they share similar key columns where one is a prefix of the other, then it is likely that one of them cannot improve the workload cost given the presence of the other. As a result, there is strong interaction between the two indexes.

Specifically, given a query q and two indexes z₁, z₂, the similarity [symbol] (z₁, z₂|q) between z₁ and z₂ with respect to q is computed as follows:
(1) Convert the query and indexes into feature vectors \vec{q}, \vec{z}₁, and \vec{z}₂. We reuse the feature representation in previous work for this purpose. In more detail, we collect all indexable columns from the workload. Let D be the number of indexable columns collected. We then represent \vec{q}, \vec{z}₁, and \vec{z}₂ as D-dimensional vectors. We assign weights to each indexable column in the query representation \vec{q} by using the approach proposed in ISUM, and we assign weights to each indexable column in the index representation \vec{z} by using the what-if call interception mechanism Wii.
(2) Project the index vectors onto the query vector using dot product, i.e.,

$${\vec{z}}_{i}^{q} = {\vec{z}}_{i} \cdot \vec{q}$$

for i∈{1,2}. Note that the resulting vectors

$${\vec{z}}_{i}^{q}$$

for i∈{1,2} remain D-dimensional vectors. This projection filters out columns in \vec{z}ᵢ that do not appear in \vec{q} (and therefore do not have impact on the query performance of q).
(3) Calculate the cosine similarity between

$${\vec{z}}_{i}^{q} and {\vec{z}}_{2}^{q} ,$$

i.e.,

$$𝒮 ( {z}_{1} , {z}_{2} \vert q ) = \frac{{\vec{z}}_{1}^{q} \cdot {\vec{z}}_{2}^{q}}{‖ {\vec{z}}_{1}^{q} ‖ \cdot ‖ {\vec{z}}_{2}^{q} ‖} .$$

[symbol] (z₁, z₂|q) can be extended to represent the similarity between an index z and an index configuration C with respect to a query q as

$$𝒮 ( z , C \vert q ) = \frac{{\vec{z}}^{q} \cdot {\vec{C}}^{q}}{‖ {\vec{z}}^{q} ‖ \cdot ‖ {C}^{q} ‖} .$$

All that is needed is a feature representation \vec{C} of the configuration C. For this purpose, an index configuration is featurized as a D-dimensional vector as follows: for each dimension d (1≤d≤D), the maximum of the feature values from the corresponding dimensions d of the feature representations of the indexes contained by the configuration are taken. The intuition is that, if an indexable column appears in multiple indexes of the configuration, the largest weight that represents its most significant role (e.g., a leading key column in some index) is taken.

Ideally, [symbol] (z, C|q) would be equal to the I(z, C|q). Unfortunately, this is not the case. It was observed that there is no strong correlation between the two. An empirical study was performed to measure the correlation between pairwise index interaction I(z₁, z₂|q) and pairwise index similarity S(z₁, z₂|q), using the workloads summarized in Table 2.

TABLE 2
Summary of database and workload statistics

| Name | DB Size | #Queries | #Tables | #Joins | #Scans | #Indexes |
|---|---|---|---|---|---|---|
| TPC-H | sf = 10 | 22 | 8 | 2.8 | 3.7 | 168 |
| TPC-DS | sf = 10 | 99 | 24 | 7.7 | 8.8 | 848 |
| JOB | 9.2 GB | 33 | 21 | 7.9 | 2.5 | 66 |
| Real-D | 587 GB | 32 | 7,912 | 17 | 17 | 417 |
| Real-M | 26 GB | 31 | 474 | 14.3 | 14.3 | 642 |

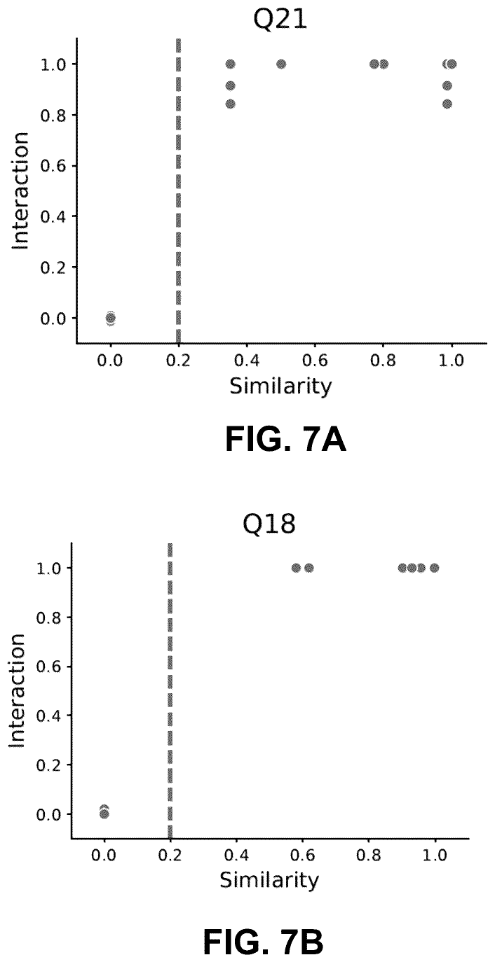

Specifically, the costliest queries for each workload were selected, and the what-if costs of all single indexes (i.e., singleton configurations) were evaluated for each query. The top 50 indexes with respect to their cost improvement (CI) were then selected in decreasing order, and the what-if costs of all 50×49=2,450 configurations that contain a pair of the top-50 indexes. Finally, the pairwise index interaction and the pairwise index similarity of these index pairs were computed. FIG. 7A and FIG. 7B present the correlation for the two most costly queries of TPC-H: query Q21 and query Q18, respectively. As can be learned from FIGS. 7A and 7B, there is no strong correlation between the two. Instead, for most of the queries, there is a sudden jump on the pairwise index interaction when the pairwise index similarity increases. That is, when the pairwise index similarity exceeds a certain threshold (e.g., 0.2), the pairwise index interaction will increase to a high value (e.g., close to 1). A threshold-based mechanism is therefore proposed to utilize the index similarity to characterize the impact of index interaction.

The basic idea is as follows. During each step of the simulated greedy search (SGS) when selecting the next index to be included, not only are the benefit of the index considered, but also its interaction with the indexes that have been selected in previous steps of SGS. Specifically, the conditional benefit

$${μ}^{( j )} ( q , {z}_{j}^{′} )$$

of the candidate index

$${z}_{j}^{′}$$

is quantified based on its interaction with the SGS-selected configuration

$${C}_{j - 1} = \{ {z}_{1}^{′} , … , {z}_{j - 1}^{′} \} ,$$

and this is used to replace the MCI upper bound

$${u}^{( j )} ( q , {z}_{j}^{′} )$$

in Procedure 2 wnich results in the following equation:

$${μ}^{( j )} ( q , {z}_{j}^{′} ) = \{ \begin{matrix}0 , & if 𝒮 ( {z}_{j}^{′} , {C}_{j - 1} \vert q ) > τ ; \\ {u}^{( j )} ( q , {z}_{j}^{′} ) , & otherwise .\end{matrix} \qquad ( 11 )$$

Here, 0≤τ≤1 is a threshold. In our experimental evaluation, this threshold-based mechanism can significantly improve the lower bound for two-phase greedy search but remains ineffective for MCTS, due to the presence of many query-index pairs with unknown what-if costs. Therefore, to optimize for MCTS for a query-index pair (q, z) with unknown what-if cost, the MCI upper bound is initialized by averaging the MCI upper bounds of indexes with known what-if costs that are similar to z with respect to q.

Based on the workload-level lower/upper bounds described above, an early-stopping verification scheme for budget-aware index tuning can be defined. One technical challenge faced in implementing this scheme is to understand when to invoke early-stopping verification. While one can employ simple strategies such as a fixed-step verification scheme where a verification is invoked every s what-if calls, such strategies may incur high computation overhead since obtaining the lower and upper bounds comes with a cost. To address this challenge, a heuristic solution to two-phase greedy search is first developed that exploits special structural properties of the two-phase greedy search algorithm. Based on this, a generic solution can be derived by only leveraging improvement rates and convexity properties of the ITC without requiring any algorithm-specific knowledge.

There is some trade-off in terms of when to invoke early-stopping verification (ESV): if ESV is invoked too frequently, then the computation overhead may become considerable; on the other hand, if ESV too late, then more what-if calls may be allocated than necessary which reduces the benefit of early stopping. There is typically no need to check for early-stopping in the early stages of index tuning, as the index tuning algorithm is likely making rapid progress. Ideally, it is possible to detect when the progress of the index tuning algorithm starts to slow down.

For two-phase greedy search, the point in the ITC where ESV should begin, also referred to herein as an inflection point, can be detected without much difficulty. As an example, consider FIG. 1A where two-phase greedy search is used to tune the TPC-H workload. In FIG. 1A, each greedy step is marked within both Phase 1 and Phase 2. As can be seen, the improvement rate starts to slow down significantly after the search enters Phase 2, especially during or after the first greedy step of Phase 2. As a result, Phase 1 can simply be skipped and early-stopping checking can start at the beginning of each greedy step of Phase 2. Experiments have confirmed that this simple scheme can result in effective early-stopping while keeping the computation overhead negligible. This heuristic early-stopping verification scheme does not work for other algorithms, such as MCTS. However, it is possible to detect similar inflection points in ITCs for these algorithms. This leads to a generic early-stopping verification scheme that only relies on improvement rates and convexity properties of ITCs.

As discussed above, the index tuning curve (ITC) comprises a function that maps from the number of what-if calls allocated at time t to the percentage improvement

$$η ( W , {C}_{t}^{*} )$$

of the corresponding best index configuration found. By definition, the ITC is monotonically non-decreasing. As noted previously, the ITC defined above cannot be directly observed without making extra what-if calls. One option that can be used to derive the ITC is to replace

$$η ( W , {C}_{t}^{*} )$$

(i.e., the percentage improvement of the best configuration found so far) with its lower bound

$${η}_{L} ( W , {C}_{t}^{*} ) .$$

However, the computation of

$${η}_{L} ( W , {C}_{t}^{*} ) = 1 - \frac{d ( W , {C}_{t}^{*} )}{c ( W , ∅ )}$$

requires running the simulated greed search which is not free. A better alternative is to use

$$1 - \frac{d ( W , {C}_{t} )}{c ( W , ∅ )} ,$$

where Cₜ is the observed best configuration at time t without continuing tuning, in lieu of

$${η}_{L} ( W , {C}_{t}^{*} ) .$$

η_{L}(W, Cₜ) is directly available at time t without extra computation. Assuming monotonicity of what-if cost (i.e., Assumption 1), then

$$η ( W , {C}_{t} ) \leq {η}_{L} ( W , {C}_{t}^{*} ) ,$$

because

$$d ( W , {C}_{t} ) \geq d ( W , {C}_{t}^{*} )$$

given that Cₜ is a subset of

$${C}_{t}^{*} .$$

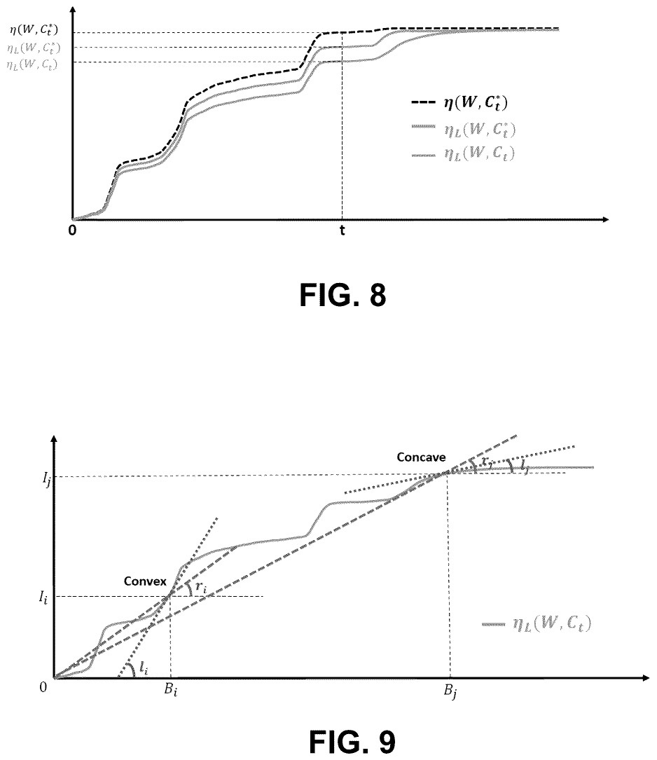

FIG. 8 characterizes this relationship between different definitions of ITC.

Suppose that early stopping checks are made at n time points with Bⱼ what-if calls allocated at time point j, where 1≤j≤n. The resulting sequence

$${\{ {B}_{j} \}}_{j = 1}^{n}$$

represents an early-stopping verification scheme (ESVS). Let the observed percentage improvement at time point j be

$${I}_{j} = {η}_{L} ( W , {C}_{{B}_{j}}^{*} ) .$$

A starting point for the scheme is defined as (B₀, I₀). Both B₀ and I₀ are known. By default, B₀=0 and I₀=0. Improvement rate can therefore be defined as follows:
Definition 1 (Improvement Rate). The improvement rate rⱼ at time point j is defined

$$as {r}_{j} = \frac{{I}_{j} - {I}_{0}}{{B}_{j} - {B}_{0}} .$$

The projected improvement at time point j for budget b of what-if calls (i.e., by making b−Bⱼ more what-if calls) can then be defined as

$${p}_{j} ( b ) = {I}_{j} + {r}_{j} \cdot ( b - {B}_{j} ) . \qquad ( 12 )$$

For the default case where

$${B}_{0} = 0 and {I}_{0} = 0 , {p}_{j} ( b ) = {I}_{j} \cdot \frac{b}{{B}_{j}} .$$

The latest improvement rate Iⱼ is defined as:
Definition 2 (Latest Improvement Rate). The latest improvement rate lⱼ at time point j is defined as

$${l}_{j} = \frac{{I}_{j} - {I}_{j - 1}}{{B}_{j} - {B}_{j - 1}} .$$

For the purposes of this disclosure, the default setup will be used in the rest of the discussion regarding early-stopping verification.

Let I=f(b) be the function that represents the ITC. That is, f(b)=η_{L}(W, C_{b}) where C_{b} is the observed best configuration with b what-if calls allocated. Using the following Lemma:
Lemma 1. If f is strictly concave and twice-differentiable, then

$${f}^{′} ( b ) < \frac{f ( b )}{b}$$

for any 0<b≤B,
enables the following theorem for concave ITCs to be defined:
Theorem 3. If f is strictly concave and twice-differentiable, then lⱼ<rⱼ for a given early-stopping verification scheme

$${\{ {B}_{j} \}}_{j = 1}^{n} .$$

The following theorem for convex ITCs can also be defined using the Lemma:
Theorem 4. If f is strictly convex and twice-differentiable, then lⱼ>rⱼ for a given early-stopping verification scheme

$${\{ {B}_{j} \}}_{j = 1}^{n} .$$

The previous analysis implies the following relationship between the improvement rates that are defined and the convexity or concavity properties of an ITC: (1) if the ITC in (Bⱼ₋₁, Bⱼ) is convex, i.e., it is making accelerating progress, then lⱼ>rⱼ will be observed; (2) on the other hand, if the index tuning curve in (Bⱼ₋₁, Bⱼ) is concave, then lⱼ<rⱼ will be observed. FIG. 9 illustrates this relationship between improvement rates and convexity/concavity for an ITC defined by η_{L}(W, Cₜ). In this example, the latest improvement rate lⱼ approximates the tangent of the ITC at the point (Bⱼ, Iⱼ).

In practice, an ITC can be partitioned into ranges where in each range the curve can fall into one of the three categories: (1) convex, (2) concave, and (3) flat (i.e., lⱼ=0). In general, the curve is more likely to be convex in early stages of index tuning and is more likely to be concave or flat towards the end of tuning. This observation leads to development of a generic ESVS, where the convexity of the ITC is leveraged to skip unnecessary invocations of early-stopping verification and to control the overall verification overhead.

The aforementioned simple ESVS is started with a fixed step size s, i.e., Bⱼ=Bⱼ₋₁+s, where s can be a small number of what-if calls. Ij and rj can then computed at each Bj accordingly. Now consider a specific time point j. If it is observed that lⱼ>rⱼ, then it is likely that the index tuning curve in (Bⱼ₋₁, Bⱼ) is convex. Note that the condition in Theorem 4 is not necessary, so the convexity is not guaranteed when observing lⱼ>rⱼ. In this case, early-stopping verification can be skipped because the improvement rate of index tuning is still increasing at a relatively high rate. On the other hand, if it is observed that lⱼ<rⱼ, then it is likely that the index tuning curve in (Bⱼ₋₁, Bⱼ) is concave, i.e., the improvement rate is decelerating, which indicates that early stopping verification should be performed. There are some challenges that need to be addressed here. For example, although it is reasonable to assume that the ITC will eventually become concave/flat, it is not guaranteed that index tuning has entered the final stage when lⱼ<rⱼ is observed. In addition, even if index tuning has entered the final stage, the improvement rate may be slow before it can be concluded that the improvement rate is lower than the threshold E), which can make early-stopping verification unnecessary.

To address these challenges, the significance of the potential concavity of the index tuning curve is measured. For this purpose, the percentage improvement at Bⱼ₊₁ is projected using the improvement rates l; and rj, and the percentage improvement at Bⱼ₊₁ is compared with Iⱼ₊₁ to decide whether early stopping verification (ESV) should be invoked at the time point j+1. Specifically, the projected improvement gap between the projected improvements

$${p}_{j + 1}^{r} and {p}_{j + 1}^{l}$$

is defined (using equation 12) as

$${Δ}_{j + 1} = {p}_{j + 1}^{r} - {p}_{j + 1}^{l} .$$

Clearly, Aⱼ₊₁>0 since lⱼ<rⱼ. Moreover, the larger Δⱼ₊₁ is, the more significant the corresponding concavity is which in turn indicates a higher probability that early stopping verification should be invoked.

Now consider the relationship between Iⱼ₊₁ and

$${p}_{j + 1}^{l , r} .$$

The following three cases are possible:

$${p}_{j + 1}^{l} < {p}_{j + 1}^{r} < {I}_{j + 1} :$$

This suggests that f grows even faster than rⱼ when moving from Bⱼ to Bⱼ₊₁, which implies that a verification at j+1 is unnecessary.

$${p}_{j + 1}^{l} < {I}_{j + 1} < {p}_{j + 1}^{r} :$$

This suggests that f grows more slowly than rⱼ but faster than lⱼ. We further define

$${δ}_{j + 1} = {p}_{j + 1}^{r} - {I}_{j + 1}$$

and define the significance of concavity σⱼ₊₁ as

$${σ}_{j + 1} = \frac{{δ}_{j + 1}}{{Δ}_{j + 1}} .$$

Clearly, 0<δⱼ₊₁<Δⱼ₊₁. We then set a threshold 0<σ<1 and perform an early-stopping verification if σⱼ₊₁≥0.

$${I}_{j + 1} < {p}_{j + 1}^{l} :$$

This suggests that f grows even more slowly than Iⱼ, which implies that a verification at j+1 is perhaps helpful.

One problem is that, if the observed improvement is flat (i.e., lᵢ=0) but the lower and upper bounds are not converging yet, then it may result in unnecessary ESV invocations. Therefore, the convergence of the bounds must be considered. Specifically, the following probabilistic mechanism for invoking ESV may be used. First, the relative gap with respect to the threshold ∈ of improvement loss is defined as

$${ρ}_{j} = \frac{{U}_{j} ( W , {C}_{B}^{*} ) - {L}_{j} ( W , {C}_{t}^{*} )}{ϵ} .$$

Instead of always invoking early stopping verification, it is invoked with probability

$${λ}_{j} = \frac{1}{{ρ}_{j}} .$$

If early-stopping verification is invoked at Bⱼ₊₁, there will be two possible outcomes:
The early-stopping verification returns true, then index tuning can be terminated accordingly.
The early-stopping verification returns false. In this case, let

$${L}_{j + 1} ( W , {C}_{t}^{*} ) and {U}_{j + 1} ( W , {C}_{B}^{*} )$$

be the lower and upper bounds returned. Lⱼ₊₁ and Uⱼ₊₁ can then be used to further refine the improvement rates lⱼ₊₁ and rⱼ₊₁. Specifically,

$${p}_{j + 2}^{r} = {I}_{j + 1} + {r}_{j + 1} \cdot s < {U}_{j + 1} and {p}_{j + 2}^{l} = {I}_{j + 1} + {i}_{j + 1} \cdot s < {U}_{j + 1}$$

gives

$${r}_{j + 1} < \frac{{U}_{j + 1} - {I}_{j + 1}}{s} and {l}_{j + 1} < \frac{{U}_{j + 1} - {I}_{j + 1}}{s} ,$$

respectively. Therefore,

$${r}_{j + 1} = min \{ \frac{{I}_{j + 1}}{{B}_{j + 1}} , \frac{{U}_{j + 1} - {I}_{j + 1}}{s} \} , and {l}_{j + 1} = min \{ \frac{{I}_{j + 1 -} {I}_{j}}{s} , \frac{{U}_{j + 1} - {I}_{j + 1}}{s} \} .$$

This refinement can be applied to all later steps j+3, j+4, . . . as well.

Standard benchmarks TPC-H, TPC-DS, and the “Join Order Benchmark” (JOB) were used as well as real customer workloads denoted herein by Real-D and Real-M. Table 2 summarizes some basic properties of the workloads, in terms of schema complexity (e.g., the number of tables), query complexity (e.g., the average number of joins and table scans contained by a query), database/workload size, and the number of candidate indexes found for index tuning.

The evaluation focused on two state-of-the-art budget-aware index tuning algorithms: two-phase greedy search and MCTS, as well as their enhanced versions with what-if call interception. The heuristic ESVS was used for two-phase greedy search and the generic ESVS was used for MCTS. Four variants were compared: (1) Esc-B, where the corresponding ESVS with lower/upper bounds that do not consider index interaction; (2) Esc-I, which further uses index interaction to refine the lower bound, as discussed above; Esc-B (FixStep), which is a baseline of Esc-B that instead adopts the fixed-step ESVS; and (4) Esc-I (FixStep), a baseline of Esc-I with the fixed-step ESVS.

For the evaluation, the improvement-loss threshold e was varied from 1% to 10% in our evaluation. For each ∈, let be b_{∈} the number of what-if calls allocated when early-stopping is triggered, and let \tilde{B} be the number of what-if calls allocated without early-stopping. Note that \tilde{B} can be smaller than the budget B on the number of what-if calls, because algorithms such as greedy search can terminate if no better configuration can be found (regardless of whether there is remaining budget on the number of what-if calls). The following performance metrics of early-stopping were measured: (a) overhead of early-stopping verification, which is measured as the total time spent on invoking early-stopping verification; (b) improvement loss, defined as

$$Δ ( {b}_{ϵ} ) = η ( W , {C}_{B}^{*} ) - η ( W , {C}_{{b}_{ϵ}}^{*} ) ;$$

and (c) savings on the number of what-if calls, defined as

$$( 1 - \frac{{b}_{ϵ}}{B} ) \times 100 \% .$$

In addition, the number of indexes allowed were varied, i.e., K∈{10, 20}, and the budget on what-if calls was set to B=20,000 to make sure that index tuning can finish without early stopping (otherwise, early stopping may not be triggered). Moreover, the threshold of index interaction for refinement of the lower-bound was set to τ=0.2. For the generic ESVS and the baseline fixed-step ESVS), the step size was set to s=100, and the threshold for the significance of concavity was set to σ=0.5.

ESC was also compared with baseline approaches that are based on simple heuristics. Specifically, for two-phase greedy search, ESC was compared with a baseline that simply stops tuning after the first phase of greedy search. For MCTS, ESC was compared with a baseline that simply stops tuning if the observed percentage improvement Iⱼ over the existing configuration is greater than some fixed threshold (i.e., 30% in this case).

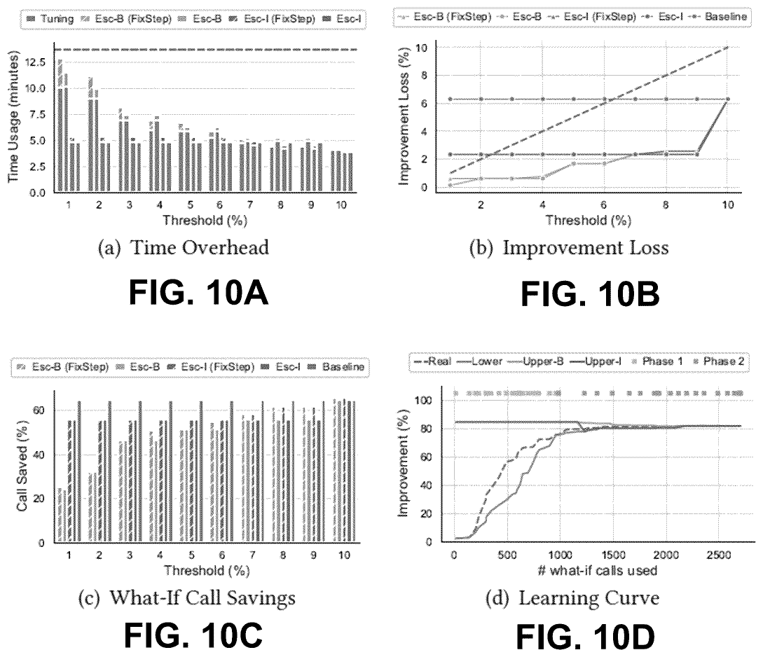

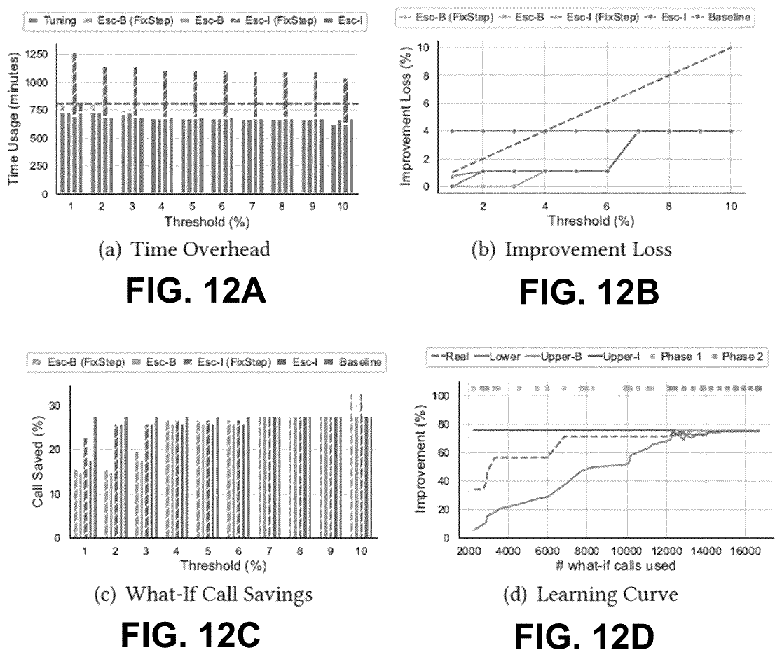

FIGS. 10-12 present the results when running two-phase greedy search on top of TPC-H, TPC-DS, and Real-D, respectively, with the number of indexes allowed K set to 20 and the budget on what-if calls B set to 20 k. FIGS. 10A, 11A, and 12A show the extra time overhead (in minutes) of early-stopping verification, FIGS. 10B, 11B, and 12B show the improvement loss when early-stopping is triggered, FIGS. 10C, 11C, and 12C show the savings on the number of what-if calls, FIGS. 10D, 11D, and 12D show the index tuning curve as well as the corresponding lower and upper bounds.

As a reference point, the dashed line in FIGS. 10A, 11A, and 12A represents the corresponding index tuning time without early-stopping verification. It can be observed that the overhead of both Esc-B and Esc-I is negligible compared to the index tuning time, across all workloads tested. On the other hand, Esc-B (FixStep) and Esc-I (FixStep) sometimes results in considerable overhead. For example, as shown in FIG. 10A, on TPC-DS, the overhead of Esc-B (FixStep) is comparable to the index tuning time when varying the threshold e from 1% to 7%.

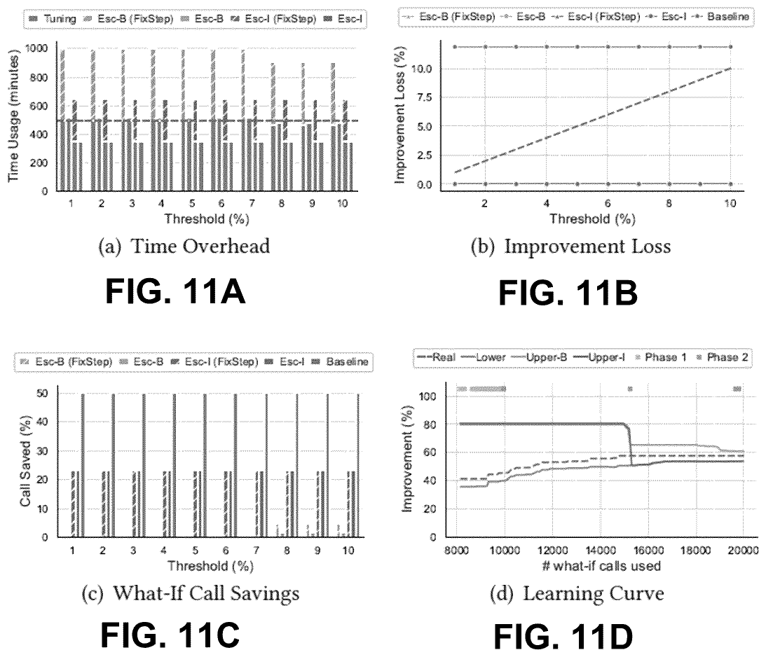

The dashed line in FIGS. 10B, 11B, and 12B delineates the acceptable improvement loss. That is, any improvement loss above that line violates the threshold E set by the user. It can be observed that violation occurs rarely, e.g., when setting e to be less than 5% on JOB, as shown in FIG. 11B. Moreover, the actual improvement loss is often much smaller than the threshold ∈ when early-stopping is triggered. One reason for this is that the lower bound

$${η}_{L} ( W , {C}_{t}^{*} )$$

and upper bound

$${η}_{U} ( W , {C}_{B}^{*} )$$

may be more conservative than the actual improvements

$$η ( W , {C}_{t}^{*} ) and η ( W , {C}_{B}^{*} )$$

needed for triggering early-stopping.

The plots shown in FIGS. 10C, 11C, and 12C represent the (percentage) savings on the number of what-if calls. As can be seen in these figures, the savings typically increase as the threshold e increases. Thus, a less stringent threshold e could be used to trigger early-stopping sooner. It can also be observed that the savings can vary on different workloads. For example, with ∈=5%, the savings are around 60% on TPC-H and JOB; however, the savings drop to 25% on TPC-DS and Real-D and further drop to 5% on Real-M. This can be understood better by looking at the corresponding index tuning curve in the plots shown in FIGS. 10D, 11D, and 12D. Finally, it can be observed that considering index interaction typically leads to an improved upper bound, which results in more savings on what-if calls.

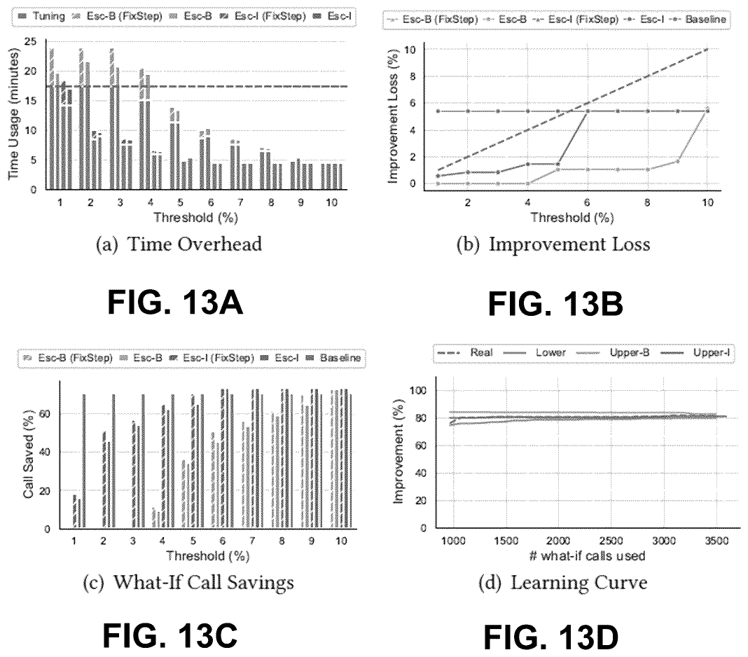

FIGS. 13A-D and 14A-D present the results for MCTS on TPC-H and Real-D. For the case of Real-M, it can be observed that the gap between the lower and upper bounds cannot be closed until the very end of index tuning, as shown in FIG. 13D. In particular, while the lower bound keeps improving, the upper bound remains constant until the middle of the first greedy step from Phase 2 of two-phase greedy search. Indeed, the real improvement is climbing even at the very end of tuning, indicating that early-stopping should not be triggered in this case (for which Esc made the right decision). Third, considering index interaction typically leads to an improved upper bound, which results in more savings on the number of what-if calls.

Again, it can be observed that the overhead of early-stopping verification is negligible compared to the index tuning time in most of the cases tested. However, there are a few cases where the early-stopping verification overhead is considerable. This typically happens when it is difficult to trigger early-stopping using the lower and upper bounds. For example, early-stopping is not triggered on TPC-DS when varying e from 1% to 10%, because the gap between the lower and upper bounds is never narrowed down below 10%. As a result, all the early-stopping verification invocations are unnecessary, which indicates opportunities for further improvement of the generic ESVS.

Meanwhile, it can again be observed that the generic ESVS can significantly reduce overhead the extra time overhead compared to the fixed-step ESVS, by comparing Esc-B and Esc-I with Esc-B (FixStep) and Esc-I (FixStep), respectively. Moreover, like in two-phase greedy search, the relationship between the extra time overhead of Esc-B and Esc-I is inconclusive. In general, each invocation of early-stopping verification using Esc-B is less expensive than using Esc-I, because considering index interactions requires more computation. However, since Esc-I improves the upper bound

$${η}_{U} ( W , {C}_{B}^{*} ) ,$$

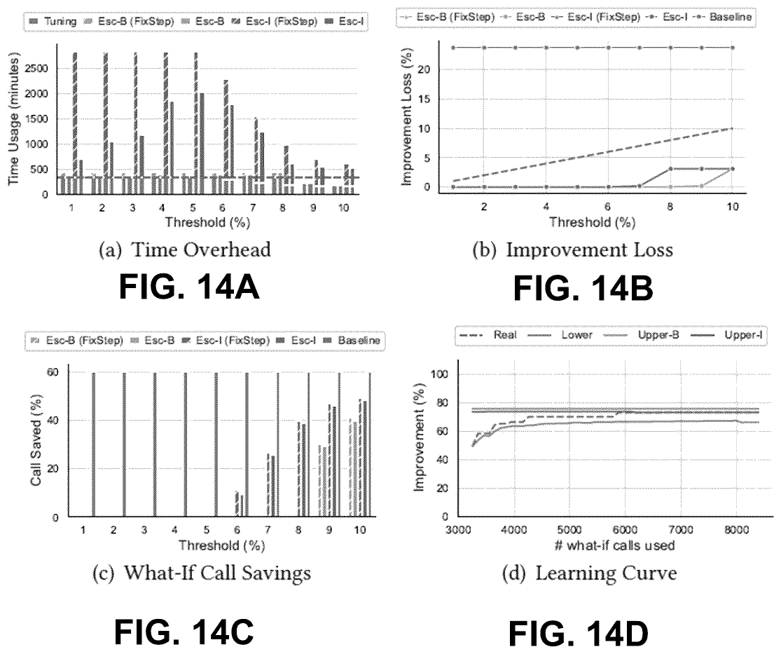

it can trigger early-stopping sooner, which leads to fewer invocations of early-stopping verification. Therefore, the overall extra time overhead of Esc-I can be smaller than that of Esc-B, as shown in FIG. 13A for TPC-H. On the other hand, the overall extra time overhead of Esc-I is considerably larger than that of Esc-B for the workload Real-D, as evidenced by FIG. 14A. Regarding the savings on end-to-end tuning time, for TPC-H the savings are similar to the corresponding savings on what-if calls, as FIG. 13C shows. For Real-D, the savings are similar when Esc-B is used, but these savings vanish when Esc-I is used due to its much higher computation overhead.

Regarding improvement loss for MCTS, like in two-phase greedy search, almost no violation of the improvement-loss threshold e is seen when early-stopping is triggered for MCTS. Moreover, the actual improvement loss is typically much lower than the threshold E.

Regarding the savings on what-if calls for MCTS, the (percentage) savings on the number of what-if calls again vary across the workloads tested. For example, on TPC-H we can save 60% what-if calls by using Esc-I when the improvement-loss threshold e is set to 5%, as shown in FIG. 13C. The actual improvement loss when early-stopping is triggered, however, is less than 2% instead of the 5% threshold, based on FIG. 13B. For Real-D, savings on what-if calls is only started with ∈>5%, though up to 40% of what-if calls can be saved when setting the threshold ∈=10% and using Esc-B, as FIG. 14C indicates. Note that, although up to 50% of what-if calls can be saved by using Esc-I, its extra time overhead is prohibitively high based on FIG. 14A, while the extra time overhead of using Esc-B is significantly lower than the overall index tuning time. Moreover, a larger threshold ∈ typically leads to larger savings on the what-if calls, as it is easier for the gap between the lower and upper bounds to meet the threshold.

Compared to the ESVS, the baseline approach that simply stops tuning after observing 30% improvement again can suffer from significant improvement loss. For example, as FIG. 14B shows, the improvement loss of the baseline on Real-D is around 25%, whereas ESC has almost no loss.

Several cases have been observed where early-stopping offers little or no benefit, e.g., when running two-phase greedy search on top of Real-M, as shown in FIG. 13, or when running MCTS on top of TPC-DS and Real-M. The main reason for this inefficacy is the slow convergence of the gap between the lower and upper bounds used for triggering early-stopping. This phenomenon can be alleviated by the what-if call interception mechanism described above, which skips inessential what-if calls whose what-if costs are close to their derived costs.

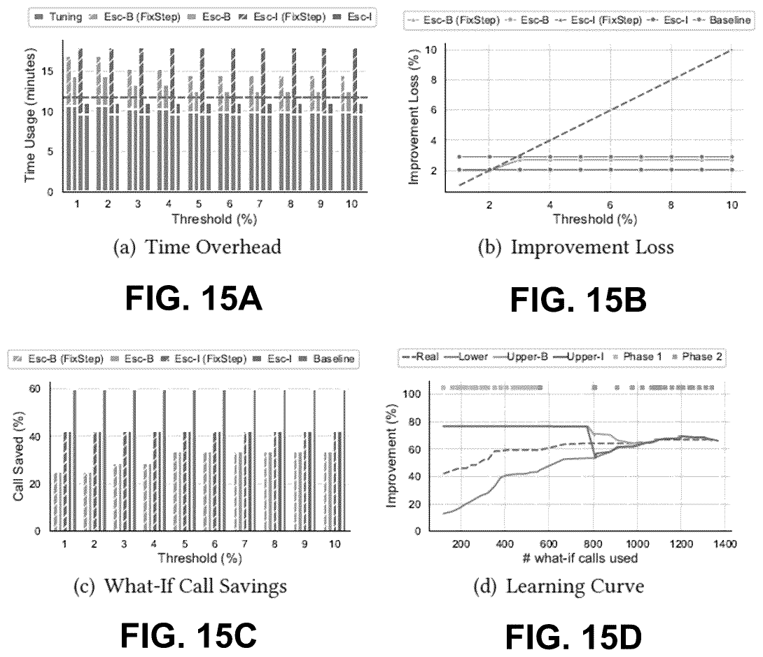

For example, the heuristic ESVS only invokes early-stopping verification when two-phase greedy search enters Phase 2, when the upper bound is expected to drop sharply. With a what-if call interception mechanism as described above integrated into two-phase greedy search, it can enter Phase 2 faster by skipping inessential what-if calls in Phase 1. As a result, Esc can be expected to be more effective for enhanced two-phase greedy search. To demonstrate this, the corresponding results for Real-M using the enhanced two-phase greedy search with the coverage-based refinement are shown in FIGS. 15A-15D. It can be observed that the savings on the number of what-if calls can further increase to 30% (using Esc-B) and 40% (using Esc-I), as shown in FIG. 15C.

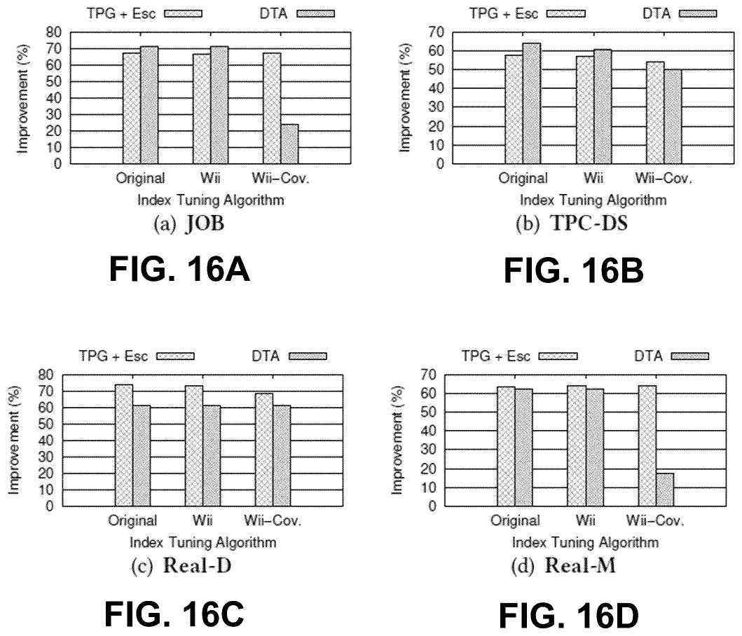

To understand the overall benefit of budget-aware index tuning with ESC enabled, when compared to other index tuning algorithms, two-phase greedy search with Esc (TPG-Esc) was compared with DTA, which employs anytime index tuning techniques that can achieve state-of-the-art tuning performance. In the evaluation, the threshold of improvement loss e was set to 5%. The corresponding time spent by TPG-Esc was measured and used as the tuning time allowed for DTA, for a fair comparison. FIGS. 16A-D present the results. The results on TPC-H were omitted as TPG-Esc and DTA achieve the same 79% improvement. The following observations were made on the workloads. On JOB, TPG-Esc significantly outperforms DTA when Wii-coverage is enabled (67% by TPG-Esc vs. 24% by DTA). On TPC-DS, TPG-Esc and DTA perform similarly. On Real-D, TPG-Esc outperforms DTA by around 10%. On Real-M, TPG-Esc significantly outperforms DTA when Wii-coverage is enabled (e.g., 64% for TPG-Esc vs. 17% for DTA).

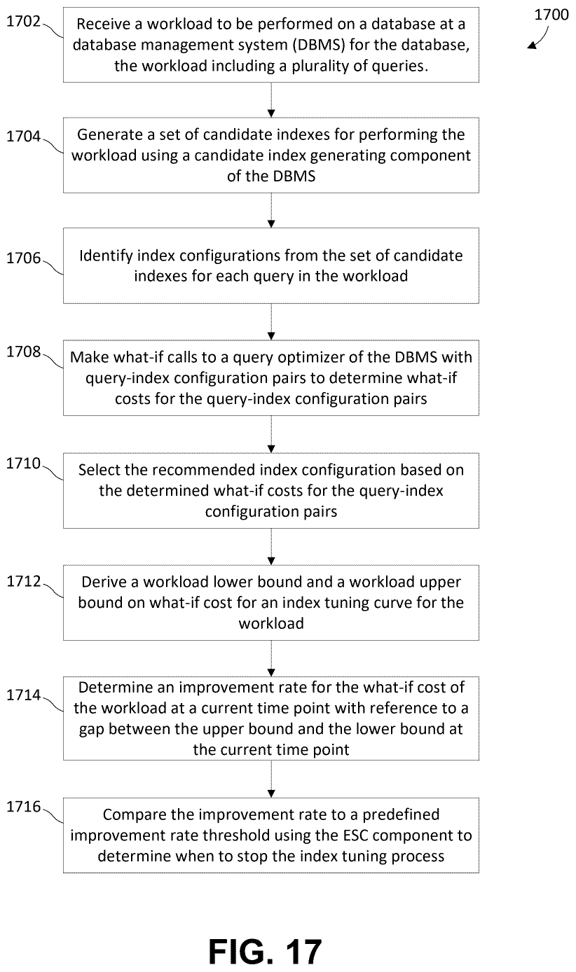

FIG. 17 shows a flowchart of an example method 1700 for index tuning with early stopping. The method begins with receiving a workload to be performed on a database at a database management system (DBMS) for the database, the workload including a plurality of queries (block 1702). A set of candidate indexes for performing the workload is then generated using a candidate index generating component of the DBMS (block 1704). A configuration enumeration component then uses a configuration enumeration algorithm to identify index configurations from the set of candidate indexes for each query in the workload that can potentially improve performance of the DBMS in processing the workload (block 1706). What-if calls are then made to a query optimizer of the DBMS with query-index configuration pairs to determine what-if costs for the query-index configuration pairs (block 1708). A recommended index configuration is then selected based on the determined what-if costs for the query-index configuration pairs (block 1710). A workload lower bound and a workload upper bound on what-if cost are then derived for an index tuning curve for the workload using an early stopping checker (ESC) component of the DBMS (block 1712). An improvement rate for the what-if cost of the workload is then determined at a current time point, the improvement rate being determined with reference to a gap between the upper bound and the lower bound for the index tuning curve at the current time point using the ESC component (block 1714). The improvement rate is then compared to a predefined improvement rate threshold using the ESC component to identify an early stopping point for the index tuning process (block 1716).

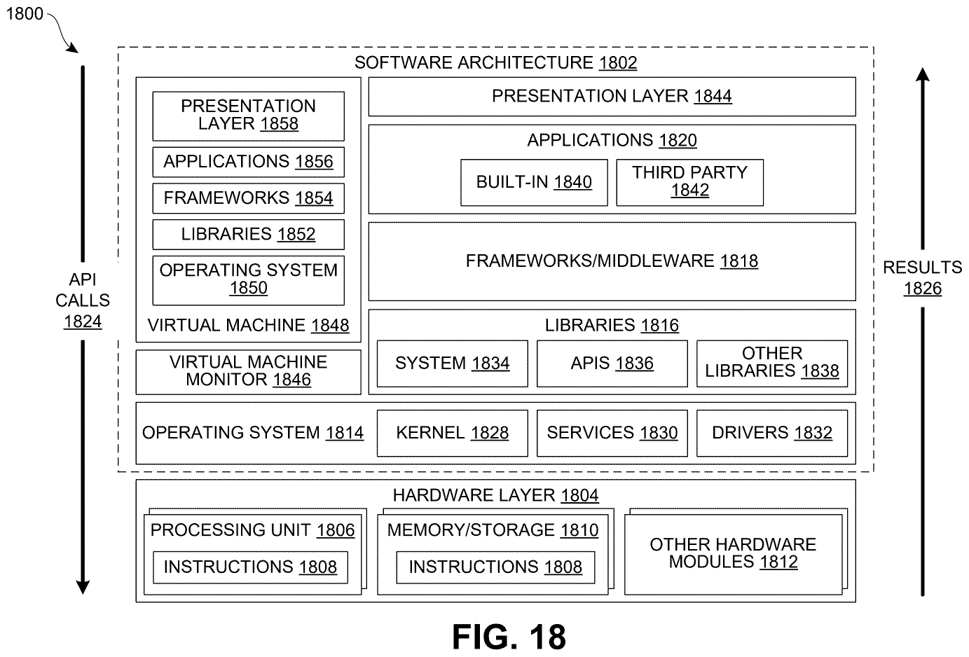

FIG. 18 is a block diagram 1800 illustrating an example software architecture 1802, various portions of which may be used in conjunction with various hardware architectures herein described, which may implement any of the above-described features. FIG. 18 is a non-limiting example of a software architecture and it will be appreciated that many other architectures may be implemented to facilitate the functionality described herein. The software architecture 1802 may execute on hardware that includes, among other things, document storage, processors, memory, and input/output (I/O) components. A representative hardware layer 1804 is illustrated and can represent, a computing device. The representative hardware layer 1804 includes a processing unit 1806 and associated executable instructions 1808. The executable instructions 1808 represent executable instructions of the software architecture 1802, including implementation of the methods, modules and so forth described herein. The hardware layer 1804 also includes a memory/storage 1810, which also includes the executable instructions 1808 and accompanying data. The hardware layer 1804 may also include other hardware modules 1812. Instructions 1808 held by processing unit 1806 may be portions of instructions 1808 held by the memory/storage 1810.

The example software architecture 1802 may be conceptualized as layers, each providing various functionality. For example, the software architecture 1802 may include layers and components such as an operating system (OS) 1814, libraries 1816, frameworks 1818, applications 1820, and a presentation layer 1844. Operationally, the applications 1820 and/or other components within the layers may invoke API calls 1824 to other layers and receive corresponding results 1826. The layers illustrated are representative in nature and other software architectures may include additional or different layers. For example, some mobile or special purpose operating systems may not provide the frameworks/middleware 1818.

The OS 1814 may manage hardware resources and provide common services. The OS 1814 may include, for example, a kernel 1828, services 1830, and drivers 1832. The kernel 1828 may act as an abstraction layer between the hardware layer 1804 and other software layers. For example, the kernel 1828 may be responsible for memory management, processor management (for example, scheduling), component management, networking, security settings, and so on. The services 1830 may provide other common services for the other software layers. The drivers 1832 may be responsible for controlling or interfacing with the underlying hardware layer 1804. For instance, the drivers 1832 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 1816 may provide a common infrastructure that may be used by the applications 1820 and/or other components and/or layers. The libraries 1816 typically provide functionality for use by other software modules to perform tasks, rather than rather than interacting directly with the OS 1814. The libraries 1816 may include system libraries 1834 (for example, C standard library) that may provide functions such as memory allocation, string manipulation, file operations. In addition, the libraries 1816 may include API libraries 1836 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 1816 may also include a wide variety of other libraries 1838 to provide many functions for applications 1820 and other software modules.

The frameworks 1818 (also sometimes referred to as middleware) provide a higher-level common infrastructure that may be used by the applications 1820 and/or other software modules. For example, the frameworks 1818 may provide various graphic user interface (GUI) functions, high-level resource management, or high-level location services. The frameworks 1818 may provide a broad spectrum of other APIs for applications 1820 and/or other software modules.

The applications 1820 include built-in applications 1840 and/or third-party applications 1842. Examples of built-in applications 1840 may include, but are not limited to, a contacts application, a browser application, a location application, a media application, a messaging application, and/or a game application. Third-party applications 1842 may include any applications developed by an entity other than the vendor of the particular platform. The applications 1820 may use functions available via OS 1814, libraries 1816, frameworks 1818, and presentation layer 1844 to create user interfaces to interact with users.

Some software architectures use virtual machines, as illustrated by a virtual machine 1848. The virtual machine 1848 provides an execution environment where applications/modules can execute as if they were executing on a hardware machine. The virtual machine 1848 may be hosted by a host OS (for example, OS 1814) or hypervisor, and may have a virtual machine monitor 1846 which manages operation of the virtual machine 1848 and interoperation with the host operating system. A software architecture, which may be different from software architecture 1802 outside of the virtual machine, executes within the virtual machine 1848 such as an OS 1850, libraries 1852, frameworks 1854, applications 1856, and/or a presentation layer 1858.

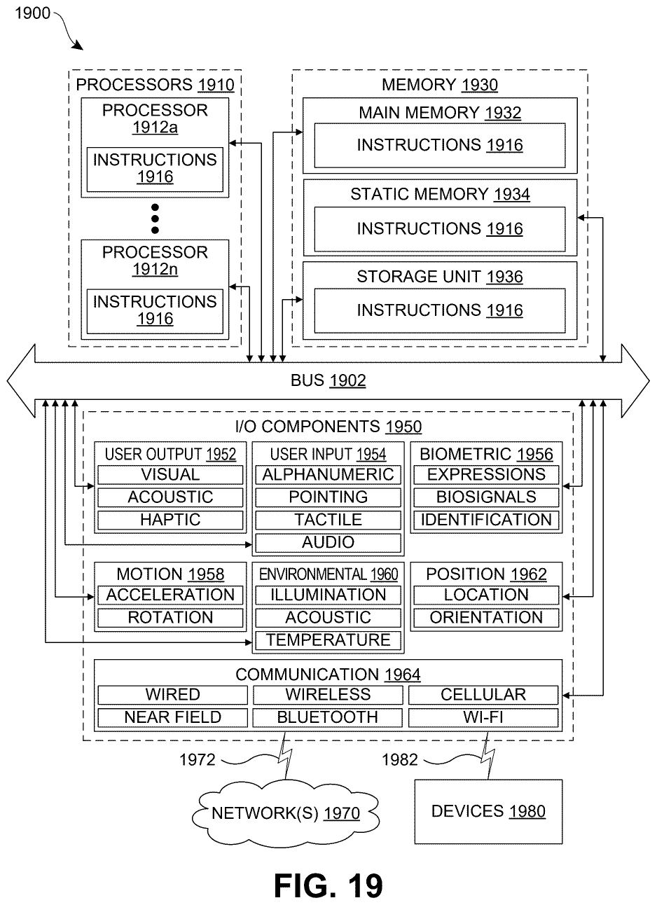

FIG. 19 is a block diagram illustrating components of an example machine 1900 configured to read instructions from a machine-readable medium (for example, a machine-readable storage medium) and perform any of the features described herein. It is to be understood that the phrase “machine-readable medium” and “computer-readable medium” are interchangeable in their usage herein. The example machine 1900 is in a form of a computer system, within which instructions 1916 (for example, in the form of software components) for causing the machine 1900 to perform any of the features described herein may be executed. As such, the instructions 1916 may be used to implement modules or components described herein. The instructions 1916 cause unprogrammed and/or unconfigured machine 1900 to operate as a particular machine configured to carry out the described features. The machine 1900 may be configured to operate as a standalone device or may be coupled (for example, networked) to other machines. In a networked deployment, the machine 1900 may operate in the capacity of a server machine or a client machine in a server-client network environment, or as a node in a peer-to-peer or distributed network environment. Machine 1900 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 1900 is illustrated, the term “machine” includes a collection of machines that individually or jointly execute the instructions 1916.

The machine 1900 may include processors 1910, memory 1930, and I/O components 1950, which may be communicatively coupled via, for example, a bus 1902. The bus 1902 may include multiple buses coupling various elements of machine 1900 via various bus technologies and protocols. In an example, the processors 1910 (including, for example, a central processing unit (CPU), a graphics processing unit (GPU), a digital signal processor (DSP), an ASIC, or a suitable combination thereof) may include one or more processors 1912a to 1912n that may execute the instructions 1916 and process data. In some examples, one or more processors 1910 may execute instructions provided or identified by one or more other processors 1910. The term “processor” includes a multi-core processor including cores that may execute instructions contemporaneously. Although FIG. 19 shows multiple processors, the machine 1900 may include a single processor with a single core, a single processor with multiple cores (for example, a multi-core processor), multiple processors each with a single core, multiple processors each with multiple cores, or any combination thereof. In some examples, the machine 1900 may include multiple processors distributed among multiple machines.

The memory/storage 1930 may include a main memory 1932, a static memory 1934, or other memory, and a storage unit 1936, both accessible to the processors 1910 such as via the bus 1902. The storage unit 1936 and memory 1932, 1934 store instructions 1916 embodying any one or more of the functions described herein. The memory/storage 1930 may also store temporary, intermediate, and/or long-term data for processors 1910. The instructions 1916 may also reside, completely or partially, within the memory 1932, 1934, within the storage unit 1936, within at least one of the processors 1910 (for example, within a command buffer or cache memory), within memory at least one of I/O components 1950, or any suitable combination thereof, during execution thereof. Accordingly, the memory 1932, 1934, the storage unit 1936, memory in processors 1910, and memory in I/O components 1950 are examples of machine-readable medium.

As used herein, “machine-readable medium” refers to a device able to temporarily or permanently store instructions and data that cause machine 1900 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 1916) for execution by a machine 1900 such that the instructions, when executed by one or more processors 1910 of the machine 1900, cause the machine 1900 to perform and one or more of the features described herein. Accordingly, a “machine-readable medium” may refer to a single storage device, as well as “cloud-based” storage systems or storage networks that include multiple storage apparatus or devices.

The I/O components 1950 may include a wide variety of hardware components adapted to receive input, provide output, produce output, transmit information, exchange information, capture measurements, and so on. The specific I/O components 1950 included in a particular machine will depend on the type and/or function of the machine. For example, mobile devices such as mobile phones may include a touch input device, whereas a headless server or IoT device may not include such a touch input device. The particular examples of I/O components illustrated in FIG. 19 are in no way limiting, and other types of components may be included in machine 1900. The grouping of I/O components 1950 are merely for simplifying this discussion, and the grouping is in no way limiting. In various examples, the I/O components 1950 may include user output components 1952 and user input components 1954. User output components 1952 may include, for example, display components for displaying information (for example, a liquid crystal display (LCD) or a projector), acoustic components (for example, speakers), haptic components (for example, a vibratory motor or force-feedback device), and/or other signal generators. User input components 1954 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 1950 may include biometric components 1956 and/or position components 1962, among a wide array of other environmental sensor components. The biometric components 1956 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 1962 may include, for example, location sensors (for example, a Global Position System (GPS) receiver), altitude sensors (for example, an air pressure sensor from which altitude may be derived), and/or orientation sensors (for example, magnetometers).

The I/O components 1950 may include communication components 1964, implementing a wide variety of technologies operable to couple the machine 1900 to network(s) 1970 and/or device(s) 1980 via respective communicative couplings 1972 and 1982. The communication components 1964 may include one or more network interface components or other suitable devices to interface with the network(s) 1970. The communication components 1964 may include, for example, components adapted to provide wired communication, wireless communication, cellular communication, Near Field Communication (NFC), Bluetooth communication, Wi-Fi, and/or communication via other modalities. The device(s) 1980 may include other machines or various peripheral devices (for example, coupled via USB).

In some examples, the communication components 1964 may detect identifiers or include components adapted to detect identifiers. For example, the communication components 1964 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 1964, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

1. A data processing system for database management system (DBMS), comprising:
at least one processor; and
a memory in communication with the at least one processor, the memory comprising executable instructions that, when executed by the processor alone or in combination with other processors, cause the data processing system to perform operations of:
receiving a workload to be performed on a database at the DBMS for the database, the workload including a plurality of queries;
generating a set of candidate indexes for performing the workload using a candidate index generating component of the DBMS;
performing an index tuning process using a configuration enumeration component of the DBMS to select a recommended index configuration to use to execute the queries in the workload, the configuration enumeration component being configured to:
use a configuration enumeration algorithm to identify index configurations from the set of candidate indexes for each query in the workload that can potentially improve performance of the DBMS in processing the workload; and
make what-if calls to a query optimizer of the DBMS with query-index configuration pairs to determine what-if costs for the query-index configuration pairs; and
select the recommended index configuration based on the determined what-if costs for the query-index configuration pairs;
deriving a workload lower bound and a workload upper bound on the what-if cost for an index tuning curve for the workload using an early stopping checker (ESC) component of the DBMS, the index tuning curve representing a function that maps a number of what-if calls allocated at time t to the index tuning process for the workload to a percentage improvement of a best index configuration found so far during the index tuning process, the workload upper bound at a time point t corresponding to a derived what-if cost for the workload based on the index configurations found by the configuration enumerator at the time point t after t what-if calls have been allocated, the workload lower bound being derived from a sum of marginal cost improvement (MCI) upper bounds for a predetermined number of indexes with a largest MCI upper bound; and
performing early stopping checks at a current time point to determine when early stopping of the index tuning process should be invoked, the early stopping checks including:
determining an improvement rate for the what-if cost of the workload at the current time point, the improvement rate being determined with reference to a gap between the upper bound and the lower bound for the index tuning curve at the current time point using the ESC component, wherein the gap corresponds to a difference between an overall improvement rate and a latest improvement rate for the what-if cost of the index tuning process at the current time point;
comparing the overall improvement rate to the latest improvement rate to determine whether the index tuning curve is convex, concave, or flat at the current time point,
continuing the early stopping checks in response to the index tuning curve being convex or flat at the current time point,
comparing the improvement rate to a predefined improvement rate threshold using the ESC component in response to the index tuning curve being concave at the current time point, to identify an early stopping point for the index tuning process;
causing the configuration enumeration component to end the index tuning process before all budgeted what-if calls have been performed in response to the early stopping point being identified; and
continuing to perform the early stopping checks until the early stopping point is identified in response the early stopping point not being identified at the current time point.

2. (canceled)

3. (canceled)

4. The data processing system of claim 1, wherein determining the improvement rate further comprises:
determining a projected improvement rate for the what-if cost that results from a next batch of what-if calls, the projected improvement rate corresponding to a difference between a projected overall improvement rate and a projected latest improvement rate after the next batch of what-if calls.

5. The data processing system of claim 1, wherein the workload upper bound and the workload lower bound are derived from call level upper bounds and call level lower bounds, respectively, determined for the what-if calls.

6. The data processing system of claim 1, wherein the configuration enumeration algorithm comprises one of a two-phase greedy search algorithm and a Monte Carlo tree search algorithm.

7. The data processing system of claim 6, wherein:
an index interaction parameter is determined for indexes selected for a query,
the index interaction parameter is a measure of a similarity between a first index and a second index for the query, and
one of the first index and the second index can be omitted from the index tuning process in response to the index interaction parameter exceeding a predefined threshold value for the similarity.

8. A method of performing index tuning with early stopping for a database, the method comprising:
receiving a workload to be performed on the database at a database management system (DBMS) for the database, the workload including a plurality of queries;
generating a set of candidate indexes for performing the workload using a candidate index generating component of the DBMS;
performing an index tuning process using a configuration enumeration component of the DBMS to select a recommended index configuration to use to execute the queries in the workload, the configuration enumeration component being configured to:
use a configuration enumeration algorithm to identify index configurations from the set of candidate indexes for each query in the workload that can potentially improve performance of the DBMS in processing the workload; and
make what-if calls to a query optimizer of the DBMS with query-index configuration pairs to determine what-if costs for the query-index configuration pairs; and select the recommended index configuration based on the determined what-if costs for the query-index configuration pairs;
deriving a workload lower bound and a workload upper bound on the what-if cost for an index tuning curve for the workload using an early stopping checker (ESC) component of the DBMS, the index tuning curve representing a function that maps a number of what-if calls allocated at time t to the index tuning process for the workload to a percentage improvement of a best index configuration found so far during the index tuning process, the workload upper bound at a time point t corresponding to a derived what-if cost for the workload based on the index configurations found by the configuration enumerator at the time point t after t what-if calls have been allocated, the workload lower bound being derived from a sum of marginal cost improvement (MCI) upper bounds for a predetermined number of indexes with a largest MCI upper bound; and
performing early stopping checks at a current time point to determine when the early stopping of the index tuning process should be invoked, the early stopping checks including:
determining an improvement rate for the what-if cost of the workload at the current time point, the improvement rate being determined with reference to a gap between the upper bound and the lower bound for the index tuning curve at the current time point using the ESC component, wherein the gap corresponds to a difference between an overall improvement rate and a latest improvement rate for the what-if cost of the index tuning process at the current time point;
comparing the overall improvement rate to the latest improvement rate to determine whether the index tuning curve is convex, concave, or flat at the current time point,
continuing the early stopping checks in response to the index tuning curve being convex or flat at the current time point,
comparing the improvement rate to a predefined improvement rate threshold using the ESC component in response to the index tuning curve being concave at the current time point, to identify an early stopping point for the index tuning process;
causing the configuration enumeration component to end the index tuning process before all budgeted what-if calls have been performed in response to the early stopping point being identified; and
continuing to perform the early stopping checks until the early stopping point is identified in response the early stopping point not being identified at the current time point.

9. (canceled)

10. (canceled)

11. The method of claim 8, wherein determining the improvement rate further comprises:
determining a projected improvement rate for the what-if cost that results from a next batch of what-if call, the projected improvement rate corresponding to a difference between a projected overall improvement rate and a projected latest improvement rate after the next batch of what-if call.

12. The method of claim 8, wherein the workload upper bound and the workload lower bound are derived from call level upper bounds and call level lower bounds, respectively, determined for the what-if calls.

13. The method of claim 8, wherein the configuration enumeration algorithm comprises one of a two-phase greedy search algorithm and a Monte Carlo tree search algorithm.

14. The method of claim 8, wherein:
an index interaction parameter is determined for indexes selected for a query,
the index interaction parameter is a measure of a similarity between a first index and a second index for the query, and
one of the first index and the second index can be omitted from index tuning process in response to the index interaction parameter exceeding a predefined threshold value for the similarity.

15. An index tuner for a database management system (DBMS), the index tuner comprising:
a workload parsing/analysis component configured to receive a workload to be performed on a database, the workload including a plurality of queries;
a candidate index generating component configured to generate a set of candidate indexes for performing the workload;
a configuration enumeration component configured to:
use a configuration enumeration algorithm to identify index configurations from the set of candidate indexes for each query in the workload that can potentially improve performance of the DBMS in processing the workload;
make what-if calls to a query optimizer of the DBMS with query-index configuration pairs to determine what-if costs for each of the query-index configuration pairs, each of the query-index configuration pairs including a query and index configurations enumerated for the query; and
combine the enumerated index configurations having a lowest what-if cost for each query in the workload to form a recommended index configuration for the DBMS to use to for the workload; and
an early stopping checker (ESC) component configured to:
perform early stopping checks at a current time point to determine when early stopping of an index tuning process should be invoked, the early stopping checks including:
determine an improvement rate for the what-if cost of the workload at the current time point, the improvement rate being determined with reference to a gap between an upper bound and a lower bound for an index tuning curve at the current time point using the ESC component, wherein the gap corresponds to a difference between an overall improvement rate and a latest improvement rate for the what-if cost of the index tuning process at the current time point;
compare the overall improvement rate to the latest improvement rate to determine whether the index tuning curve is convex, concave, or flat at the current time point,
continue the early stopping checks in response to the index tuning curve being convex or flat at the current time point,
compare the improvement rate to a predefined improvement rate threshold using the ESC component in response to the index tuning curve being concave at the current time point, to identify an early stopping point for the index tuning process;
cause the configuration enumeration component to end the index tuning process before all budgeted what-if calls have been performed in response to the early stopping point being identified; and
continue to perform the early stopping checks until the early stopping point is identified in response the early stopping point not being identified at the current time point.

16. (canceled)

17. (canceled)

18. (canceled)

19. The index tuner of claim 15, wherein;
a candidate index for a current query being processed and a current recommended index configuration for the workload are compared to determine an index interaction parameter;
the determined index interaction parameter is compared to a predetermined index interaction threshold; and
an MCI upper bound for the candidate index is included or omitted from a derivation of the workload upper bound based on a result of a comparison.

20. The index tuner of claim 19, wherein the index interaction parameter is based on a calculated similarity between the candidate index the current recommended index configuration.
